(19) United States
(12) Patent Application Publication
(10) Pub. No.: US 2025/0133543 A1
(43) Pub. Date: Apr. 24, 2025

(54) METHOD PERFORMED BY NETWORK NODE IN COMMUNICATION SYSTEM AND NETWORK NODE

(71) Applicant: Samsung Electronics Co., Ltd., Suwon-si (KR)

(72) Inventors: Yue YUAN, Beijing (CN); Mingli WANG, Beijing (CN); Nan CAO, Beijing (CN); Fang XIE, Beijing (CN); Mei LIU, Beijing (CN); Jiankang WANG, Beijing (CN)

(21) Appl. No.: 18/931,837

(22) Filed: Oct. 30, 2024

Related U.S. Application Data
(63) Continuation of application No. PCT/KR2024/012815, filed on Aug. 27, 2024.

(30) Foreign Application Priority Data
Oct. 23, 2023 (CN) 202311378614.9

(51) Int. Cl. H04W 72/0446

(52) U.S. Cl. CPC H04W 72/0446

(57) ABSTRACT

The disclosure relates to a method performed by a network node in a communication system and the network node, which relates to a field of artificial intelligence. The method comprises: determining a first resource allocation pattern corresponding to at least one cell; obtaining a second resource allocation pattern corresponding to the at least one cell, by adjusting the first resource allocation pattern of the at least one cell based on information related to interference between cells. The method may be performed by an electronic apparatus and may be performed using an artificial intelligence model.

### CROSS-REFERENCE TO RELATED APPLICATIONS

This application is a continuation of International Application No. PCT/KR2024/012815 designating the United States, filed on Aug. 27, 2024, in the Korean Intellectual Property Receiving Office and claiming priority to Chinese Patent Application No. 202311378614.9 filed on Oct. 23, 2023, in the Chinese Patent Office, the disclosures of each of which are incorporated by reference herein in their entireties.

### BACKGROUND

### Field

The disclosure relates to a field of a communication technology, and for example, the disclosure relates to a method and a network node performed by a network node in a communication system.

### Description of Related Art

In a 5G system, a Distributed Unit (DU) of a base station periodically transmits a communication prediction request to a Centralized Unit (CU). After receiving the communication prediction request, the CU predicts which time domain resources will have data traffic in a future period (e.g., predicts a resource allocation pattern (which may also referred to as energy-saving pattern)) using information such as Reference Signal (RS) information, Physical Resource Block (PRB) utilization rate, traffic load, etc. collected from the DU, and feedbacks a prediction result to the DU. Thereafter, the DU performs an energy-saving operation based on the received prediction result (e.g., the resource allocation pattern). Specifically, time domain resource allocation of data traffic is centralized, e.g., the data traffic dispersed on a time dimension is centralized as much as possible in the same time domain for transmission, so as to increasing more idle time domains. Then, cell resources are switched off on the idle time domains, e.g., a Radio Unit (RF) apparatus performs a turnoff of a power amplifier.

How to generate the resource allocation pattern more rationally and thus better resource allocation to meet a communication requirement is a technical problem that those skilled in the art have been working hard to study.

### SUMMARY

Embodiments of the disclosure provide a method performed by a network node and the network node.

According to an example embodiment, a method performed by a first network node in a communication system is provided, which includes: determining a first resource allocation pattern corresponding to at least one cell; obtaining a second resource allocation pattern corresponding to the at least one cell, by adjusting the first resource allocation pattern of the at least one cell based on information related to interference between cells.

The first resource allocation pattern may include a movability level corresponding to a resource unit, the movability level representing a level of resource adjustment for a resource unit in a time domain.

The movability level may be related to at least one of a traffic load, a traffic priority, and a delay-related characteristic of a traffic.

The determining the first resource allocation pattern corresponding to the at least one cell includes: acquiring attribute-related information of the at least one cell; determining the first resource allocation pattern corresponding to the at least one cell based on the attribute-related information.

The attribute-related information includes historical traffic information and/or energy-saving time granularity information.

The determining the first resource allocation pattern corresponding to the at least one cell based on the attribute-related information includes: allocating available resources for the at least one cell; determining, via a first neural network, a predicted traffic load of the at least one cell and movability levels corresponding to resource units to which resources have been allocated, based on the historical traffic information; determining the first resource allocation pattern corresponding to the at least one cell based on the energy-saving time granularity information, the allocated available resources, the predicted traffic load, and the movability levels corresponding to the resource units to which the resources have been allocated.

The first neural network includes a first sub-neural network, a second sub-neural network and a third sub-neural network, the determining, via the first neural network, the predicted traffic load of the at least one cell and the movability levels corresponding to the resource units to which the resources have been allocated, based on the historical traffic information includes: determining, through the first sub-neural network, the predicted traffic load of the at least one cell based on the historical traffic information; determining, through the second sub-neural network, delay-related characteristics of the resource units to which the resources have been allocated, based on the predicted traffic load and traffic types corresponding to the resource units to which the resources have been allocated; determining, through the third sub-neural network, the movability levels corresponding to the resource units to which the resources have been allocated, based on the delay-related characteristics of the resource units to which the resources have been allocated.

The historical traffic information includes at least one historical traffic log; the determining, through the first sub-neural network, the predicted traffic load of the at least one cell based on the historical traffic information includes: determining, through a temporal convolutional network in the first sub-neural network, the predicted traffic load of each historical traffic log corresponding to each resource unit based on the at least one historical traffic log of the at least one cell; obtaining the predicted traffic load of the at least one cell, by fusing, through a fusion network in the first sub-neural network, the predicted traffic load of each historical traffic log corresponding to each resource unit, for the at least one cell.

The delay-related characteristic includes at least one of a resource type, a traffic priority, and a maximum acceptable delay.

The adjusting the first resource allocation pattern of the at least one cell based on the information related to interference between cells includes: obtaining at least one cell cluster by clustering the at least one cell; obtaining a corresponding second resource allocation pattern by adjusting a first resource allocation pattern of at least one cell within a cell cluster, based on the information related to interference between cells within each cell cluster.

The clustering the at least one cell includes: clustering the at least one cell based on the information related to interference of the at least one cell.

An interference intensity between cells within one cell cluster is not less than a set threshold; an interference intensity between cells in different cell clusters is less than the set threshold.

The adjusting the first resource allocation pattern of the at least one cell based on the information related to interference between cells includes: adjusting the first resource allocation pattern of the at least one cell based on the movability levels corresponding to the resource units and an interference relationship between cells.

The adjusting the first resource allocation pattern of the at least one cell based on the movability levels corresponding to the resource units and the interference relationship between cells includes: adjusting, through a second neural network, locations of the resource units in the time domain in the first resource allocation pattern of the at least one cell based on the movability levels corresponding to the resource units and the interference relationship between cells.

The adjusting, through the second neural network, the locations of the resource units in the time domain in the first resource allocation pattern of the at least one cell based on the movability levels corresponding to the resource units and the interference relationship between cells includes: obtaining at least one group of resource allocation pattern segment, by segmenting the first resource allocation pattern of the at least one cell according to a first length; adjusting, through the second neural network, the locations of the resource units in the time domain in the at least one group of resource allocation pattern segment based on the movability levels corresponding to the resource units and the interference relationship between cells; obtaining a corresponding second resource allocation pattern by splicing the adjusted at least one group of resource allocation pattern segment.

The method may further include: obtaining a third resource allocation pattern of the at least one cell, by compressing continuous resource units having the same movability level in the second resource allocation pattern of the at least one cell.

The compressing the continuous resource units having the same movability level in the second resource allocation pattern of the at least one cell includes: obtaining an energy-saving weight factor of the at least one cell; and compressing the continuous resource units having the same movability level in the second resource allocation pattern of the at least one cell based on the energy-saving weight factor of the at least one cell.

The method may further include: performing iterative operations including: determining whether the third resource allocation pattern of the at least one cell satisfies a specified criteria; based on an iteration end condition not being satisfied, adjusting the third resource allocation pattern and compressing the continuous resource units having the same movability level in the adjusted third resource allocation pattern.

The iteration end condition includes: the number of the iterations satisfies a specified number of times; and/or, a gain of a throughput and a gain of the energy-saving of the at least one cell no longer grows.

The method may further include: transmitting the second resource allocation pattern corresponding to the at least one cell to a second network node.

The first network node is a radio access network intelligent controller (RIC), and the second network node is a distribution unit (DU).

According to an example embodiment, a method performed by a second network node in a communication system is provided, the method includes: receiving a second resource allocation pattern of at least one cell transmitted by a first network node, wherein the second resource allocation pattern is obtained by the second network node adjusting a first resource allocation pattern of at least one cell based on information related to interference between cells;

performing a corresponding resource scheduling processing based on the second resource allocation pattern.

The method may further include: transmitting attribute-related information of the at least one cell to the first network node, for the first network node to determine the first resource allocation pattern corresponding to the at least one cell based on the attribute-related information.

The attribute-related information includes historical traffic information and/or energy-saving time granularity information.

The method may further include: transmitting information related to interference of at least one cell to the first network node.

The method may further include: selecting a corresponding energy-saving weight factor from among a plurality of specified energy-saving weight factors based on a deployment scenario and/or traffic load-related information of the at least one cell corresponding to the second network node; transmitting the selected energy-saving weight factor to the first network node.

The first network node is a radio access network intelligent controller (RIC), and the second network node is a distribution unit (DU).

According to an example embodiment, a first network node is provided, which includes: a transceiver configured to transmit and/or receive a signal; and at least one processor, comprising processing circuitry, coupled to the transceiver and individually and/or collectively configured to perform the method performed by the first network node as described above.

According to an example embodiment, a second network node is provided, which includes: a transceiver configured to transmit and/or receive a signal; and at least one processor, comprising processing circuitry, coupled to the transceiver and individually and/or collectively configured to perform the method performed by the second network node as described above.

According to an example embodiment, a non-transitory computer-readable storage medium storing instructions is provided, wherein the instructions, when executed by at least one processor, comprising processing circuitry, individually and/or collectively, cause the first network node or the second network node to perform the method performed by the first network node or the method performed by the second network node as described above.

The beneficial effects of the advantages provided by the various example embodiments will be described in the greater detail below, or may be understood from descriptions of the various example embodiments.

### BRIEF DESCRIPTION OF THE DRAWINGS

The above and other aspects, features and advantages of certain embodiments of the present disclosure will be more apparent from the following detailed description, taken in conjunction with the accompanying drawings, in which:

FIG. 1 is a flowchart illustrating an example method performed by a first network node in a communication system according to various embodiments;

FIG. 2A is a flowchart illustrating an example process for determining a first resource allocation pattern corresponding to at least one cell according to various embodiments;

FIG. 2B is a flowchart illustrating an example process for determining a first resource allocation pattern corresponding to at least one cell according to various embodiments;

FIG. 3 is a diagram illustrating an example structure of a first neural network according to various embodiments;

FIG. 4 is a flowchart illustrating an example process of determining, by a first neural network, a predicted traffic load of at least one cell and movability levels corresponding to resource units to which resources have been allocated, according to various embodiments;

FIG. 5 is a diagram illustrating an example process for determining, by a first neural network, a predicted traffic load of at least one cell according to various embodiments;

FIG. 6 is a diagram illustrating determined predicted traffic load according to various embodiments;

FIG. 7 is a diagram illustrating an example process for determining, by a second sub-neural network, a delay-related characteristic of resource units to which resources have been allocated, for a cell according to various embodiments;

FIG. 8 is a diagram illustrating an example process for determining, by a third sub-neural network, movability levels of resource units to which resources have been allocated, according to various embodiments;

FIG. 9A is a diagram illustrating a first resource allocation pattern corresponding to a cell generated by a first network node according to various embodiments;

FIG. 9B is a diagram illustrating an example process for determining a first resource allocation pattern corresponding to at least one cell according to various embodiments;

FIG. 10 is a flowchart illustrating an example process for adjusting a first resource allocation pattern of the at least one cell based on information related to interference between cells according to various embodiments;

FIG. 11A is a diagram illustrating an example process for segmenting a first resource allocation pattern according to various embodiments;

FIG. 11B is a diagram illustrating an example process for adjusting, by a second neural network, each group of resource allocation pattern segment according to various embodiments;

FIG. 11C is a diagram illustrating a comparison between a first resource allocation pattern before the adjustment of the at least one cell and a corresponding second resource allocation pattern obtained by the adjustment to the first resource allocation pattern according to various embodiments;

FIG. 12 is a flowchart illustrating an example process for adjusting a first resource allocation pattern of the at least one cell based on information related to interference between cells according to various embodiments;

FIG. 13 is a diagram illustrating receiving, by a first network node, information related to interference of a cell from a base station according to various embodiments;

FIG. 14 is a diagram illustrating an example of a neighbor list and an interference information list according to various embodiments;

FIG. 15 is a diagram illustrating a result of cell clustering according to various embodiments;

FIG. 16 is a flowchart illustrating an example method performed by a first network node according to various embodiments;

FIG. 17A is a graph illustrating a relationship between an average data transmission rate and a SNIR of a UE according to various embodiments;

FIG. 17B is a diagram illustrating a relationship between interference between cells, a traffic transmission duration Time, and a transmission rate f(SINR) according to various embodiments;

FIG. 18 is a diagram illustrating an example of determining, by an energy-saving weight factor β, an energy-saving duration according to various embodiments;

FIGS. 19A and 19B are diagrams illustrating energy-saving effects when energy-saving weight factors take different values according to various embodiments;

FIG. 20 is a diagram illustrating an example process for adjusting an anti-interference energy-saving pattern based on an energy-saving weight factor according to various embodiments;

FIG. 21 is a flowchart illustrating an example method performed by a second network node in a communication system according to various embodiments;

FIG. 22 is a flowchart illustrating an example process for determining, by a first network node and a second network node, a final resource allocation pattern according to various embodiments;

FIGS. 23A, 23B, 23C and 23D are diagrams illustrating an example process for adjusting a resource allocation pattern according to various embodiments;

FIG. 24 is a diagram illustrating an example deployment scenario between a network node and a base station according to various embodiments;

FIG. 25A is a block diagram illustrating an example configuration of a first network node according to various embodiments;

FIG. 25B is a block diagram illustrating an example configuration of a second network node according to various embodiments;

FIG. 26 is a block diagram illustrating an example configuration of an electronic apparatus according to various embodiments;

FIG. 27A is a diagram illustrating a comparison result of applying a scheme according to various embodiments and the prior art under a first assessment condition;

FIG. 27B is a diagram illustrating a distribution of three neighboring cells according to various embodiments;

FIG. 28 is a diagram illustrating a comparison result of applying a scheme according to various embodiments and the prior art under a second assessment condition.

### DETAILED DESCRIPTION

The following description is made with reference to the accompanying drawings and is provided to aid in understanding of various example embodiments of the present disclosure.

This description includes various specific details to aid in understanding but should only be considered as examples. Accordingly, those ordinary skill in the art will recognize that various changes and modifications can be made to the various embodiments described herein without departing from the scope and spirit of the present disclosure. In addition, descriptions of well-known features and structures may be omitted for the sake of clarity and brevity.

The terms and phrases used in the following description and claims are not limited to dictionary meaning thereof, but are used to enable a clear and consistent understanding of the present disclosure. Accordingly, it should be apparent to those skilled in the art that, the following description of the various embodiments of the present disclosure is provided for an illustrative purpose only and is not intended to limit the present disclosure.

It should be understood that, “a”, “an” and “the” in a singular form may also include a plural reference, unless the context clearly indicates otherwise. Thus, for example, a reference to a “part surface” includes a reference to one or more such surfaces. When it refers to one element as being “connected” or “coupled” to another element, the one element may be directly connected or coupled to the other element, or it may refer to a connection relationship between the one element and the other element established through an intermediate element. In addition, “connected” or “coupled” as used herein may include wirelessly connected or wirelessly coupled.

The term “include” or “may include” refers to the presence of a function, operation, or component of the corresponding disclosure that may be used in the various embodiments of the present disclosure, and does not limit the presence of one or more additional functions, operations, or features. In addition, the terms “include” or “have” may be interpreted to denote certain features, figures, steps, operations, elements, components, or combinations thereof, but should not be interpreted to exclude the possibility of the presence of one or more other features, figures, steps, operations, elements, components, or combinations thereof.

The term “or” as used in the various embodiments of the present disclosure includes any of the listed terms and all combinations thereof. For example, “A or B” may include A, may include B, or may include both A and B. When describing a plurality of (two or more) items, the plurality of items may refer to one, more, or all of the plurality of items if a relationship among the plurality of items is not explicitly defined. For example, for the description “a parameter A comprises A1, A2, A3”, it may be implemented as parameter A comprising A1, A2 or A3, or as parameter A comprising at least two of the three items of the parameter A1, A2, A3.

All terms (including technical or scientific terms) used in the present disclosure have the same meaning described in the present disclosure as understood by those skilled in the art, unless defined differently. Common terms as defined in dictionaries are interpreted to have a meaning consistent with the context in the relevant technology art and should not be interpreted in an idealized or overly formalistic manner, unless expressly so defined in the present disclosure.

At least part of the functions in a device or electronic apparatus provided in the embodiments of the present disclosure may be implemented through an AI model, such as, at least one of a plurality of modules of the device or electronic apparatus may be implemented through the AI model. A function associated with AI may be performed through the non-volatile memory, the volatile memory, and the processor.

The processor may include one or more processors. The one or more of processors may be a general purpose processor, such as a central processing unit (CPU), an application processor (AP), or the like, or may be a graphics-only processing unit such as a graphics processing unit (GPU), a visual processing unit (VPU), and/or an AI-dedicated processor such as a neural processing unit (NPU).

The one or more processors control processing of input data in accordance with a predefined operating rule or artificial intelligence (AI) model stored in the non-volatile memory and the volatile memory. The predefined operating rule or artificial intelligence model is provided through training or learning.

For example, the processor according to an embodiment of the disclosure may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions.

Being provided through learning may refer, for example, to, by applying a learning algorithm to a plurality of learning data, a predefined operating rule or an AI model of a desired characteristic being made. The learning may be performed in a device or electronic apparatus itself in which AI according to an embodiment is performed, and/or may be implemented through a separate server/system.

The AI model may include a plurality of neural network layers. Each layer may have a plurality of weight values, and performs a neural network calculation by calculating between the input data of this layer (such as, a calculation result of the previous layer and/or the input data of the AI model) and the plurality of weight values of the current layer. Examples of neural networks include, but are not limited to, a convolutional neural network (CNN), a deep neural network (DNN), a recurrent neural network (RNN), a restricted Boltzmann Machine (RBM), a deep belief network (DBN), a bidirectional recurrent deep neural network (BRDNN), a generative adversarial networks (GAN), and a deep Q-network.

The learning algorithm may include a method for training a predetermined target device (for example, a robot) using a plurality of learning data to cause, allow, or control the target device to make a determination or prediction. Examples of the learning algorithm include, but are not limited to, supervised learning, unsupervised learning, semi-supervised learning, or reinforcement learning.

According to the present disclosure, at least one of operations in a method performed by a network node, such as operations of predicting a traffic load and a traffic type, extracting a delay-related characteristic and so on, may be implemented using an artificial intelligence model. A processor of the electronic apparatus may perform a pre-processing operation on data to convert it into a form suitable for use as input to the artificial intelligence model. The artificial intelligence model may be obtained through training. Here, “obtained through training” may refer, for example, to training a basic artificial intelligence model with a plurality of training data through a training algorithm to obtain the predefined operation rule or AI model, which are configured to perform the required features (or purposes).

The related art includes problems of a system performance loss and an insufficient energy efficiency for the following main reasons:
(1) System performance loss: the related solutions bring about interference lifting, which leads to a decrease in cell throughput. For example, the related solutions are carried out independently within a cell, and each cell does not know a data traffic distribution of other cells. Each cell carries out resource adjustment according to a principle of data traffic concentration, and it is easy to appear that the resources of the cells are concentrated in the same time domain for scheduling, thus forming interference between cells. The interference lifting makes a Signal to Interference plus Noise Ratio (SINR) decrease, which leads to a Block Error Ratio (BLER) increase. In addition, based on a link adaptation mechanism, a system decreases a Modulation and Coding Scheme (MCS) to maintain a convergence of the BLER. Accordingly, the decrease of the MCS leads to a decrease in transmission efficiency, so that the same traffic takes more time to complete a transmission, resulting in a decrease in the throughput.
(2) Insufficient energy-saving efficiency: the related solutions will make a change of interference over time more apparent, cause an apparent fluctuation of the SINR, affect the transmission efficiency, and lead to waste of time-domain resources, then which leads to the insufficient energy-saving efficiency. Specifically, the related solutions do not carry out inter-cell collaboration, so an impact of resource adjustment on a channel environment cannot be accurately evaluated within the cell. If the SINR of part of a time domain range rises after the resource adjustment, however, because the cell cannot accurately evaluate a change in the SINR, a lower MCS is still used for traffic transmission, thereby failing to utilize a proper transmission efficiency and lengthening a time of the traffic transmission, which reduces the time during which resource may be switched off, and reduces the energy-saving efficiency.

To this end, various embodiments of the disclosure provide a method capable of generating a resource allocation pattern performed by a network node. For example, the method is capable of obtaining locations in the time domain and movability levels of a traffic in a future period of time by predicting a traffic load and a delay characteristics of the traffic of each cell in a future period of time, and generating a traffic delay-aware resource allocation pattern (which may also be referred to as an energy-saving pattern, a resource allocation design, an energy-saving design, etc.) for each cell. The movability level refers to an adjustable range of a traffic resource in the time domain. Unlike the energy-saving pattern of the traditional solutions, the traffic delay-aware energy-saving pattern reflects a resource movability of different traffics in consideration of the traffic flow and traffic characteristics. Furthermore, the example method is capable of generating the adjusted energy-saving pattern (which may also be referred to as an anti-interference energy-saving pattern, an anti-interference energy-saving design, etc.), by adjusting the traffic delay-aware energy-saving pattern of each cell based on interference between cells. Specifically, when there are traffic resources to be transmitted between cells within the same transmission time interval of the traffics, due to the movability of the traffic resources of the cells, the traffic resources of some of these cells may be moved to the previous or subsequent transmission moments in order to be staggered in the time domain with the traffic resources of the other cells, and the traffic delay-aware energy-saving patterns of all the cells are adjusted within a range of a cell cluster based on a minimum interference criterion, this adjustment will reduce the interference between cells and increase the SINR of each cell. Furthermore, due to the increase of the SINR of each cell, the channel quality becomes better, so that a higher-order MCS may be selected for coding during the traffic transmission, which makes it possible to reduce the time required for transmitting the same amount of data as before, and based on this, the method may further adjust the interference-aware energy-saving pattern, thereby further reducing a traffic transmission duration in the anti-interference energy-saving pattern, and thus further improving the energy-saving efficiency of the cells.

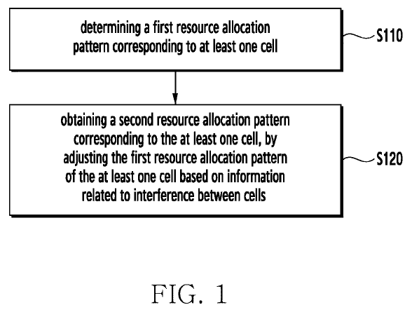

FIG. 1 is a flowchart illustrating an example method performed by a first network node in a communication system according to various embodiments.

As shown in FIG. 1, at operation S110, a first resource allocation pattern corresponding to at least one cell is determined.

In an example embodiment, the first resource allocation pattern corresponding to the cell may be determined based on a related known method.

In an example embodiment, the first resource allocation pattern corresponding to the cell may be determined according to the disclosure as described herein. The first resource allocation pattern includes a movability level corresponding to a resource unit, the movability level represents a level of resource adjustment for a resource unit in a time domain. For example, the movability level indicates an adjustable range for the resource unit in a time domain. Wherein, the resource unit represents a Transmission Time Interval (TTI) for traffic transmission in the time domain, and represents a time granularity available for energy-saving.

For example, the determining the first resource allocation pattern corresponding to the at least one cell may include: acquiring attribute-related information of the at least one cell.

The first network node may receive the attribute-related information of the cell from a base station (e.g., from a DU of the base station), wherein the attribute-related information includes historical traffic information and/or energy-saving time granularity information. The energy-saving time granularity information may be Power Amplifier (PA) switching-off time granularity information (it may also be referred to as RU switching-off time granularity information. The terms “PA is switched off”, “switching off PA”, “RU is switched off, and “switching off RU” are used interchangeably, and “PA is switched on”, “switching on PA”, “RU is switched on”, and “switching on RU” are used interchangeably), the historical traffic information may include at least one historical traffic log (e.g., a historical traffic load and a traffic type), and in addition, the attribute-related information may further include a public signal and a Reference Signal (RS). Wherein, the first network node may be a Radio Access Network (RAN) Intelligent Controller (RIC), but the disclosure is not limited thereto.

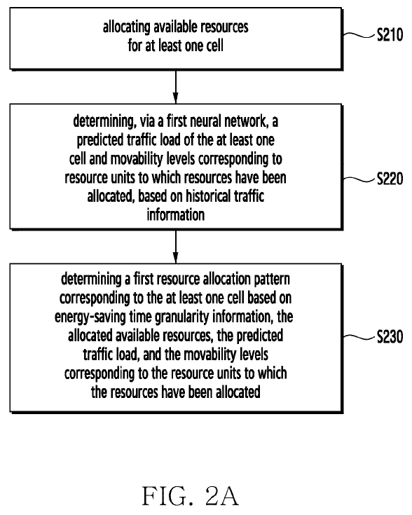

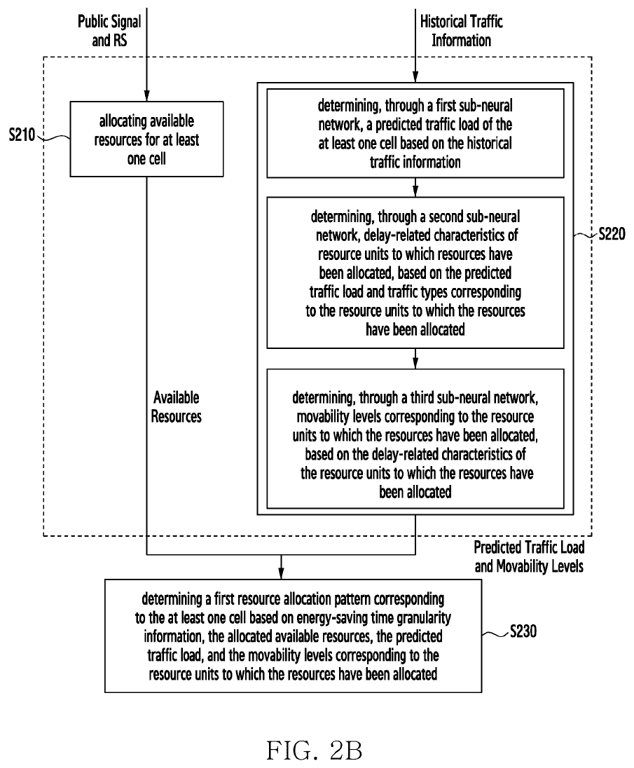

The determining the first resource allocation pattern corresponding to the at least one cell may further include: determining the first resource allocation pattern corresponding to the at least one cell based on the attribute-related information. This is described in greater detail below with reference to FIG. 2A.

FIG. 2A is a flowchart illustrating an example process for determining a first resource allocation pattern corresponding to at least one cell according to various embodiments.

At operation S210, available resources are allocated for the at least one cell.

The available resources may be determined for the at least one cell based on the public signal and the RS. For example, the available resources may be allocated for the cell among the resources that are not occupied by the public signal and the RS. For example, the first network node may determine the available resources for the cell using the public signal and the RS included in the attribute-related information of the cell received from the base station, such that the available resources do not conflict with the resources occupied by the public signal and the RS.

At operation S220, a predicted traffic load of the at least one cell and movability levels corresponding to resource units to which resources have been allocated are determined based on the historical traffic information via a first neural network, and the resource unit to which the resource has been allocated represents that the PA is not switched off for this resource unit, and the resource unit to which the resource has not been allocated represents that the PA is switched off for this resource unit.

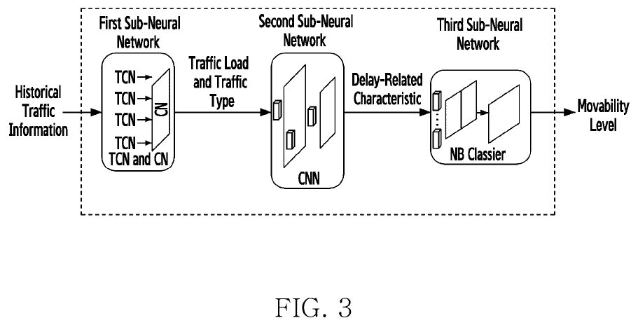

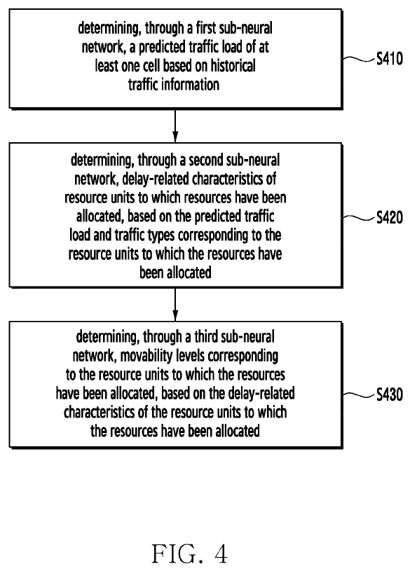

For example, the historical traffic information of the cell received by the first network node from the base station is input to the first neural network, and the first neural network performs a prediction operation based on the input historical traffic information, so that the predicted traffic load of the cell in a future period of time and movability levels corresponding to the resource units to which resources have been allocated may be obtained. As shown in FIG. 3, the first neural network includes a first sub-neural network, a second sub-neural network, and a third sub-neural network, wherein the first sub-neural network may include a Temporal Convolutional Networks (TCN) and a Concatenation Network (CN), and the second sub-neural network may include a Deep Learning Convolution Neural Network (CNN), and the third sub-neural network may include a Naïve Bayes Classifier (NB), but the disclosure is not limited thereto. The operation S220 will be described in greater detail below with reference to FIGS. 3 and 4.

FIG. 4 is a flowchart illustrating an example process for determining, by a first neural network, a predicted traffic load of at least one cell and movability levels corresponding to resource units to which resources have been allocated according to various embodiments.

At operation S410, the predicted traffic load of the at least one cell is determined based on the historical traffic information through the first sub-neural network, wherein the predicted traffic load is used to indicate resource units that will be occupied by each traffic of the corresponding cell. As described above, the historical traffic information includes at least one historical traffic log.

For example, the predicted traffic load of each historical traffic log corresponding to each resource unit is determined based on the at least one historical traffic log of the at least one cell through a TCN in the first sub-neural network.

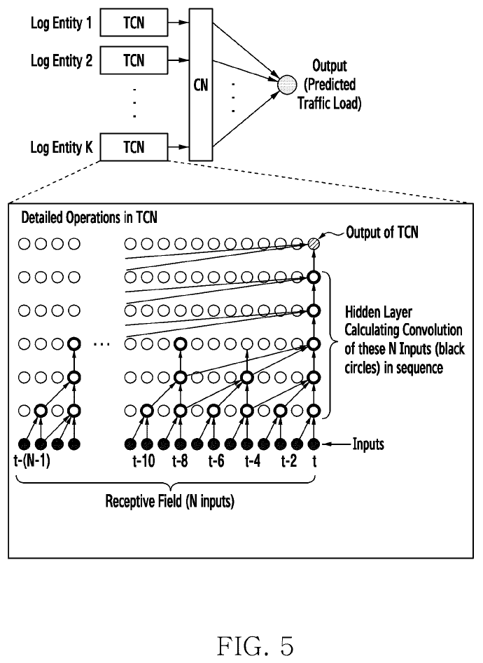

As shown in FIG. 5, an input to the first sub-neural network is historical traffic information. For example, K historical traffic logs (hereinafter, referred to as log entities), and accordingly, the first sub-neural network may include K TCNs and one fusion network (e.g., a CN), wherein each of the K log entities is input into a corresponding one of the K TCNs, and each TCN may process the one input log entity using an operation process in the lower schematic diagram in FIG. 5. For example, the log entity inputted into each TCN is divided into N inputs, that is, N time-series data (e.g., t to t−(N−1) inputs), then a convolution of these N inputs is calculated in sequence by hidden layers in the TCN, and finally, an output of the TCN may be obtained, that is, the predicted traffic load of the each historical traffic log corresponding to each resource unit is determined.

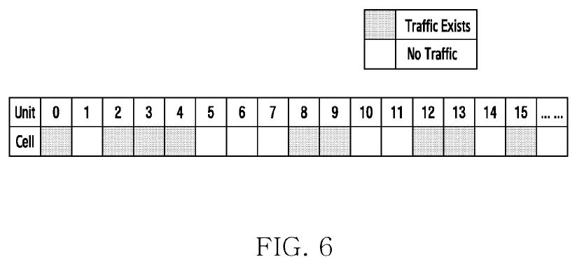

The predicted traffic load of the at least one cell is obtained by fusing the predicted traffic load of each historical traffic log corresponding to each resource unit through the fusion network (e.g., a CN) in the first sub-neural network, for the at least one cell. For example, the traffic load of the at least one cell in a future period of time is predicted, as shown in FIG. 6, wherein white color represents no traffic, and gray color represents the presence of traffic, but at this time the various traffic is not differentiated by characteristics. So far, the predicted traffic load of each of the at least one cell may be obtained.

Returning to the reference to FIG. 4, at operation S420, delay-related characteristics of the resource units to which the resources have been allocated are determined based on the predicted traffic load and traffic types corresponding to the resource units to which the resources have been allocated through the second sub-neural network.

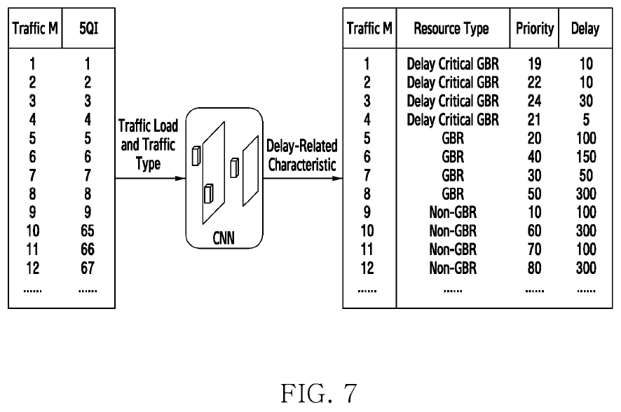

As shown in FIG. 3, the predicted traffic load determined by the first sub-neural network with respect to the cell and the traffic types corresponding to the resource units to which the resources have been allocated are input to the second sub-neural network. As shown in FIG. 7, the second sub-neural network determines, with respect to the cell, the delay-related characteristics of the resource units to which the resources have been allocated based on the inputs, and the delay-related characteristics may include, for example, at least one of a resource type, a traffic priority, and a maximum acceptable delay, wherein the resource type may be, for example, a Guaranteed Bit Rate (GBR) type, a Non-GBR type and a Delay Critical GBR, the traffic priority may be, for example, 5, 7, 10, 15, 19, 20 . . . , the maximum acceptable delay may be, for example, 5 ms, 10 ms, 30 ms, 50 ms . . . . So far, the delay-related characteristics of the resource units to which the resources have been allocated of each of the at least one cell may be obtained.

At operation S430, the movability levels corresponding to the resource units to which the resources have been allocated are determined, based on the delay-related characteristics of the resource units to which the resources have been allocated, through the third sub-neural network.

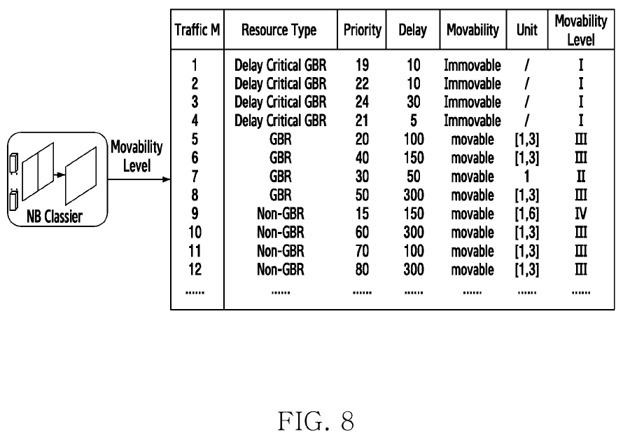

As shown in FIG. 3, the delay-related characteristics of the resource units to which the resources have been allocated determined by the second sub-neural network are input to the third sub-neural network, and then, a classification operation is performed by the third sub-neural network using the input delay-related characteristics to predict the movability levels corresponding to the resource units to which the resources have been allocated. As shown in FIG. 8, the third sub-neural network may obtain, for each cell, the movability levels of the resource unit to which the resources have been allocated by classifying the input delay-related characteristics. As described above, the third sub-neural network may be a Bayes Classifier NB, which defines combinations of different probabilities as a plurality of movability levels using probabilities of occurrence of different characteristics in historical traffic transmissions, for example, four movability levels: a movability level I indicating that it is immovable, a movability level II indicating that up to one resource unit can be moved, a movability level III indicating that up to three resource units can be moved, and a movability level IV indicating that up to six resource units can be moved, but the disclosure is not limited thereto, and the number of movability levels may be other values, for example, 3, 5, 7, etc., and the maximum number of movable resource units of each movability level is not limited thereto.

By the operation S220 described above, the predicted traffic load of the at least one cell and the corresponding movability levels of the resource units to which the resources have been allocated may be determined, and as described above, the movability levels may be related to at least one of the traffic load, the traffic priority, and the delay-related characteristic of the traffic.

Returning to the reference to FIG. 2A, at operation S230, the first resource allocation pattern corresponding to the at least one cell is determined based on the energy-saving time granularity information, the allocated available resources, the predicted traffic load, and the movability levels corresponding to the resource units to which the resources have been allocated.

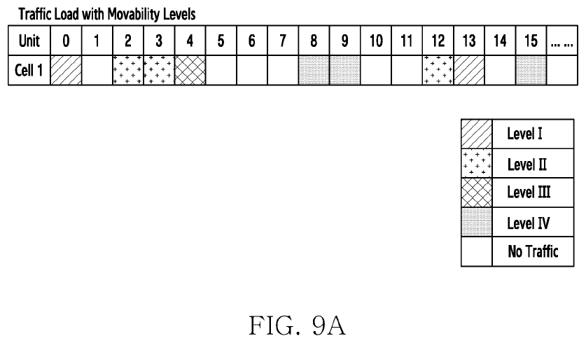

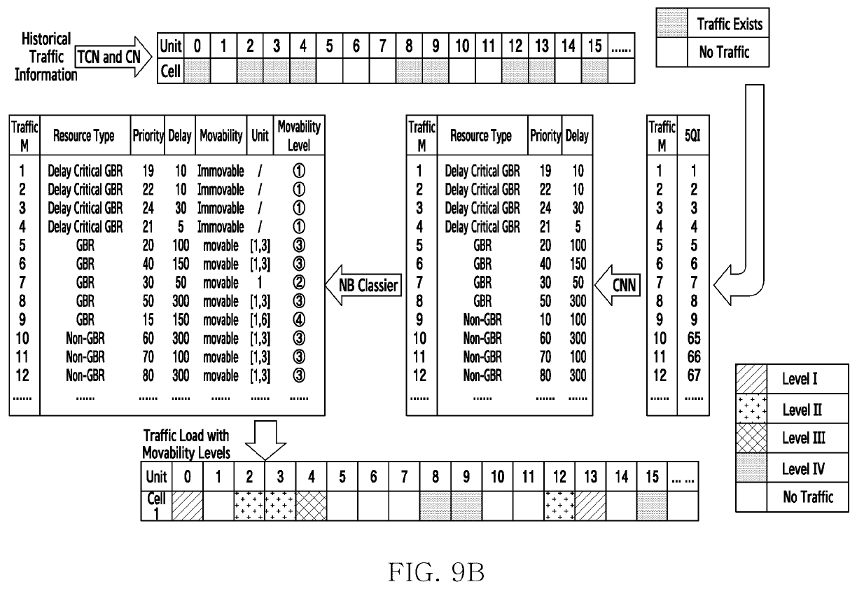

For example, the first network node may determine sizes of resource units in a resource allocation pattern for the corresponding cell based on the energy-saving time granularity information of the cell received from the base station, e.g., determines whether a resource unit is of a timeslot level or a sub-frame level, etc. Thereafter, the first network node determines the first resource allocation pattern corresponding to the cell based on the available resources allocated for the cell, the predicted traffic load, and the mobility levels corresponding to the resource units to which the resources have been allocated. FIG. 9A illustrates a first resource allocation pattern corresponding to a cell generated by a first network node, wherein each resource unit in the first resource allocation pattern has a movability level, wherein orange represents a movability level I, blue represents a movability level II, yellow represents a movability level III, green represents a movability level IV, and white represents no traffic.

In the process for determining the first resource allocation pattern corresponding to the at least one cell based on the attribute-related information described above with reference to FIG. 2A, the operation S210 is described firstly, followed by the operation S220, however, the disclosure is not limited thereto, and the order in which the operations S210 and S220 are performed is not limited, and it is also possible to perform the operation S220 firstly, followed by the operation S210, and it is also possible to perform the operations S210 and S220 simultaneously as shown in FIG. 2B.

FIG. 9B is a diagram illustrating an example process for determining a first resource allocation pattern corresponding to at least one cell according to various embodiments, which may summarize an overall process illustrated and described with reference to FIGS. 6 to 9A.

As shown in FIG. 9B, a first sub-neural network (e.g., a TCN and a fusion network (e.g., a CN)) determines a predicted traffic load of the at least one cell (e.g., the result in FIG. 6), and, a second sub-neural network (e.g., a CNN) determines delay-related characteristics of the resource units to which the resources have been allocated (e.g., the result in FIG. 7) based on the predicted traffic load determined by the first sub-neural network and traffic types corresponding to resource units to which the resources have been allocated, a third sub-neural network (e.g., a NB classifier) determines movability levels corresponding to the resource units to which the resources have been allocated (e.g., the result in FIG. 8) based on the delay-related characteristics of the resource units to which the resources have been allocated determined by the second sub-neural network, and the first network node determines the first resource allocation pattern corresponding to the at least one cell (e.g., the result in FIG. 9A) based on energy-saving time granularity information, allocated available resources, the predicted traffic load, and the movability levels corresponding to the resource units to which the resources have been allocated.

Returning to refer to FIG. 1, at operation S120, a second resource allocation pattern corresponding to the at least one cell is obtained by adjusting the first resource allocation pattern of the at least one cell based on information related to interference between cells, wherein the information related to interference between cells includes an interference relationship between cells.

For example, the first resource allocation pattern of the at least one cell may be adjusted based on the movability levels corresponding to the resource units and the interference relationship between cells.

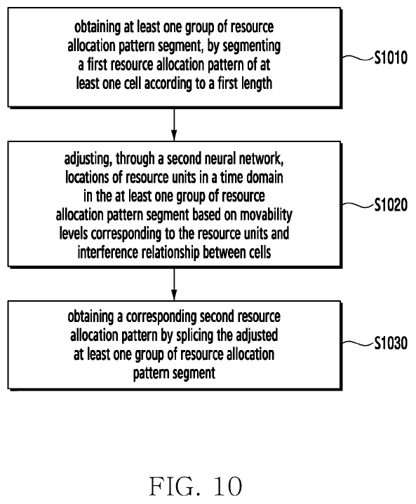

In an example embodiment, the adjusting the first resource allocation pattern of the at least one cell based on the movability levels corresponding to the resource units and the interference relationship between cells may include: adjusting, through a second neural network, locations of the resource units in the time domain in the first resource allocation pattern of the at least one cell based on the movability levels corresponding to the resource units and the interference relationship between cells. This is described in greater detail below with reference to FIG. 10.

FIG. 10 is a flowchart illustrating an example process for adjusting a first resource allocation pattern of the at least one cell based on information related to interference between cells according to various embodiments.

As shown in FIG. 10, at operation S1010, at least one group of resource allocation pattern segment is obtained by segmenting the first resource allocation pattern of the at least one cell according to a first length, wherein the first length is a data input length supported by the second neural network.

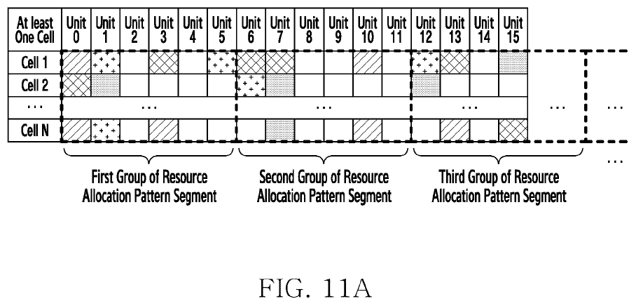

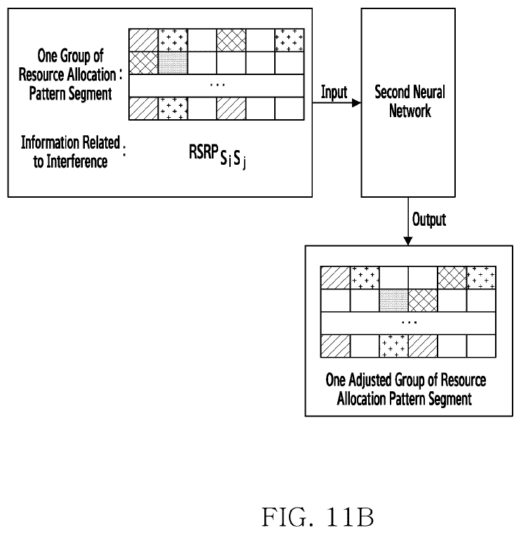

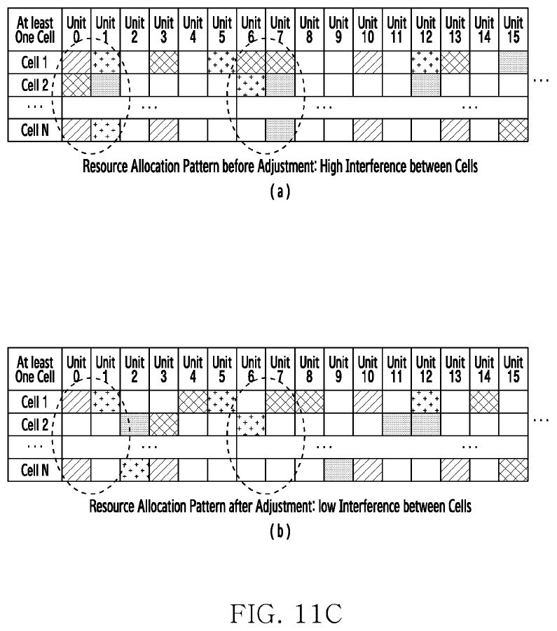

As shown in FIG. 11A, the first resource allocation pattern of the at least one cell is segmented according to the data input length supported by the second neural network, thereby obtaining at least one group of resource allocation pattern segment, wherein the next group of resource allocation pattern segment starts at an end of the previous group of resource allocation pattern segment.

At operation S1020, the locations of the resource units in the time domain in the at least one group of resource allocation pattern segment is adjusted based on the movability levels corresponding to the resource units and the interference relationship between cells through the second neural network.

For example, based on the movability levels corresponding to the resource units and the interference relationship between the cells, the locations of the resource units in the time domain in each group of resource allocation pattern segment is adjusted by the second neural network aiming at minimizing the interference between the cells, and in an example embodiment of the disclosure, the adjustment criterion of each group of resource allocation pattern segment may be set as the following equation (1):

$$min {\sum }_{t = 0}^{T} {\sum }_{{S}_{i} = 0}^{N} {\sum }_{{S}_{j} \neq {S}_{i}}^{N} {RSRP}_{{S}_{i} , {S}_{j}} {k}_{{S}_{i} , t} {k}_{{S}_{j} , t} \qquad ( 1 )$$

where T is a duration of one group of resource allocation pattern segment; N represents the number of cells; RSRP_{S}_{ᵢ}_{,S}_{ⱼ} represents the an interference to a cell Sᵢ by a cell Sⱼ (also referred to as “interference relationship”); k_{S}_{ᵢ}_{,t} represents that, in the one group of resource allocation pattern segment, if for the cell Sᵢ, resources are not allocated on a resource unit t (e.g., a RU is switched off), k_{S}_{ᵢ}_{,t} is 0, and if for the cell Sᵢ, resources are allocated on the resource unit t (e.g., the RU is switched on), k_{S}_{ᵢ}_{,t} is 1; similarly, k_{S}_{ⱼ}_{,t} has a similar meaning.

Therefore, in order to minimize and/or reduce the criterion expressed in the equation (1), as many subitems as possible should be 0. If the interference between cells are large, then RSRP_{S}_{ᵢ}_{,S}_{ⱼ} is not 0. If k_{S}_{ᵢ}_{,t} or k_{S}_{ⱼ}_{,t} is 0, then there is no interference between the cells k_{S}_{ᵢ}_{,t} and k_{S}_{ⱼ}_{,t}, and then the entire subitem is 0. Therefore, it is necessary to make the number of k=0 as large as possible. By solving the above equation (1), the adjustment of each group of resource allocation pattern segment may be finally implemented.

As shown in FIG. 11B, a first network node inputs one group of resource allocation pattern segment and the interference relationship between cells of each cell corresponding to this one group of resource allocation pattern segment to a second neural network, wherein each resource unit in the one group of resource allocation pattern segment has a movability level. The second neural network, aiming at minimizing the interference between cells, adjusts the locations of the resource units in a time domain in the one group of resource allocation pattern segment based on movability levels corresponding to the resource units and the interference relationship between cells, and finally, the adjustment of each group of resource allocation pattern segment may be implemented. In similar manners, the adjustment of each group of resource allocation pattern segment may be implemented. In the disclosure, the second neural network may be, for example, a Feed forward neural network (FFNN), but the disclosure is not limited thereto.

At operation S1030, a corresponding second resource allocation pattern is obtained by splicing the adjusted at least one group of resource allocation pattern segment.

For example, the first network node may splice the adjusted at least one group of resource allocation pattern segment in a time sequence, so that the second resource allocation pattern of the at least one cell may be obtained. FIG. 11C is a diagram illustrating a comparison between a first resource allocation pattern before the adjustment of the at least one cell (e.g., (a) of FIG. 11C) and a corresponding second resource allocation pattern obtained by the adjustment to the first resource allocation pattern. As shown in (b) in FIG. 11C, it can be seen that after the first resource allocation pattern is adjusted, for resource units where interference between cells originally exists, after adjusting the locations of these resource units in the time domain based on the corresponding movability levels of the resource units and the interference relationship between cells, the interference between cells may be decreased, thereby causing an increase in the SINR of each cell and thus an increase in the transmission efficiency.

By operations S1010 to S1030, the second resource allocation pattern for the at least one cell may be obtained, thereby improving the transmission efficiency of the cell, and the cell may shorten the traffic transmission time for the same traffic and provide more idle time for switching off the RU to achieve energy-saving.

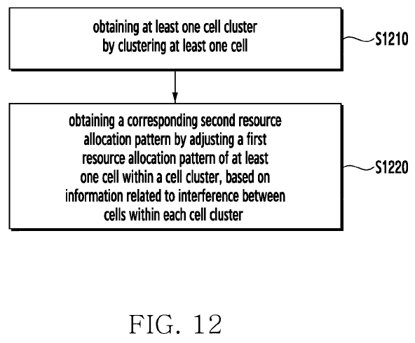

In addition, when the number of cells of the at least one cell described above with reference to FIG. 10 is large, in order to further reduce the complexity and increase the transmission efficiency of the cell, at least one cell may be clustered and an adjustment process similar to the first resource allocation pattern described above with reference to FIG. 10 may be performed for each cell cluster. This is described in greater detail below with reference to FIG. 12.

FIG. 12 is a flowchart illustrating an example process for adjusting a first resource allocation pattern of the at least one cell based on information related to interference between cells according to various embodiments.

At operation S1210, at least one cell cluster is obtained by clustering the at least one cell. In an example embodiment, the first network node may cluster the at least one cell based on information related to interference of the at least one cell. The “information related to interference” herein has the same meaning as the information related to interference between cells mentioned above, and both represent the interference to this cell by another cell.

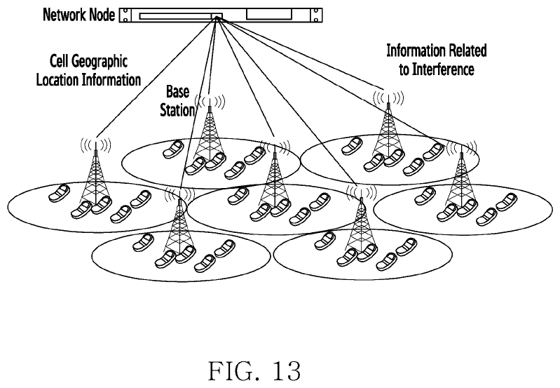

A first network node may receive the information related to interference of the at least one cell from the base station, wherein the information related to interference of one cell may be used to represent interference to this cell by another cell, for example, this interference may be represented by a Reference Signal Receiving Power (RSRP). As shown in FIG. 13, the first network node may periodically receive the information related to interference of the cell from the base station, and furthermore, the first network node may receive the cell geographic location information of the cell from the base station during initial deployment of the base station.

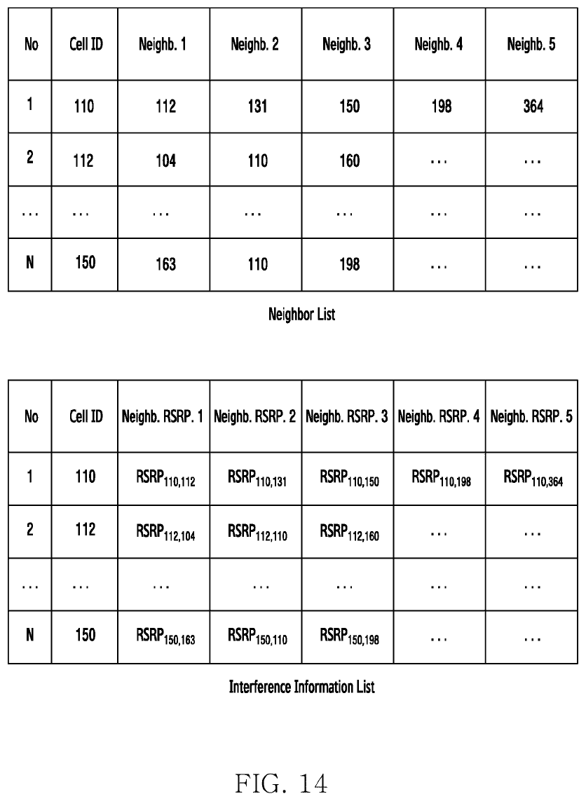

The first network node may generate a neighbor list and an interference information list based on the information related to interference of the at least one cell and the cell geographic location information. FIG. 14 illustrates an example of a neighbor list and an interference information list according to an example embodiment, wherein, in the neighbor list, No represents the serial number of a cell, a cell Identity (ID) represents a physical ID of the cell, and a Neighb.X represents a neighboring cell ID centered on the cell ID; and in the interference information list, a No represents the serial number of a cell, a cell ID represents a physical ID of the cell, and a Neighb.RSRP.X represents an interference generated by the neighboring cell IDs centered on the cell ID, e.g., RSRP_{112,110} represents an interference generated by a cell 110 to a cell 112.

The first network node clusters the at least one cell based on the neighbor list and the interference information list.

When clustering the at least one cell, an interference intensity between cells within one cell cluster is not less than a set threshold, and an interference intensity between cells in different cell clusters is less than the set threshold, wherein the set threshold is preset or may be set at any time according to an actual environment, and the disclosure does not make specific limitations thereon.

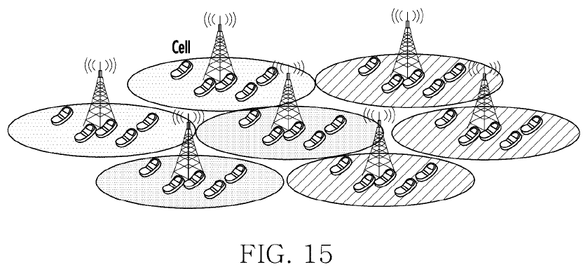

For example, the plurality of cells may be clustered based on a K-averaging algorithm, aiming at maximizing and/or increasing the interference within the cell clusters, such that cells of which the interfere with each other not less than the set threshold are divided into the same cell cluster, e,g, such that cells that have the strong interference with each other are divided into the same cell cluster. Specifically, it is assumed that the final cell clusters are C1, C2, . . . and Ck, the following objective function (2) is set using the K-averaging algorithm, and the final clustering result may be determined by solving with the goal of minimizing this objective function, wherein k represents the number of final clusters, which is a positive integer greater than or equal to 1.

$$E = {\sum }_{p = 1}^{k} {\sum }_{\begin{matrix}Si ∈ {C}_{p} \\ Sj \neq Si\end{matrix}} {‖ {RSRP}_{Si , Sj} - {μ}_{p} ‖}^{2} \qquad ( 2 )$$

$${μ}_{p} = \frac{1}{{N}_{p}} {\sum }_{\begin{matrix}Si ∈ {C}_{p} \\ Sj \neq Si\end{matrix}} {RSRP}_{Si , Sj} \qquad ( 3 )$$

Wherein Cₚ represents the pth cell cluster; Sᵢ and Sⱼ represent a cell Sᵢ and cell Sⱼ within the pth cell cluster, respectively; RSRP_{S}_{ᵢ}_{,S}_{ⱼ} represents an interference to cell Sᵢ generated by the neighboring cell Sⱼ reported by the cell Sᵢ to the network node, which may be obtained by looking up the neighbor list and the interference information list generated above; μₚ represents an average interference power within the pth cell cluster; Nₚ represents the number of cells that have received the reported interference powers of neighboring cells counted within a cell cluster Cₚ. By the above method, the cells with strong interference with each other may be divided into the same cell cluster, as shown in FIG. 15, cells in the dark orange are divided into one cell cluster, cells in light orange are divided into another cell cluster, and cells in the green are divided into yet another cell cluster, which makes the interferences between cell clusters be weakened, and the strong interferences be concentrated within the cell cluster, so that it is easy to effectively processing of the strong interference within the cell cluster.

Returning to the reference to FIG. 12, at operation S1220, a corresponding second resource allocation pattern is obtained by adjusting a first resource allocation pattern of at least one cell within a cell cluster, based on the information related to interference between cells within each cell cluster.

Due to the high interference between cells within each cell cluster and the fact that the resources in the first resource allocation pattern may be concentrated to be scheduled in the same time domain, the first resource allocation pattern of the cells in the cell cluster needs to be adjusted. In detail, the process for adjusting the first resource allocation pattern described above with reference to FIG. 10 may be applied to the operation S1220, for example, with respect to at least one cell within each cell cluster, the first resource allocation pattern of this at least one cell may be adjusted based on the information related to interference between the cells in this at least one cell.

For example, at least one group of resource allocation pattern segment is obtained by segmenting a first resource allocation pattern of at least one cell in one cluster according to a first length, wherein the first length is a data input length supported by the second neural network.

The locations of the resource units in the time domain in the at least one group of resource allocation pattern segment are adjusted based on the movability levels corresponding to the resource units and the interference relationship between cells in this one cell cluster through the second neural network. For example, the above equation (1) may still be used to represent the adjustment criterion of each group of resource allocation pattern segment, wherein N represents the number of cells in this one cell cluster, and other symbols in the equation (1) (e.g., T, t, Sⱼ, Sᵢ, etc.) have the same meanings described above with reference to FIG. 10, and furthermore, since the interference within the cell clusters is large, RSRP_{S}_{ᵢ}_{,S}_{ⱼ} is not 0, and if k_{S}_{ᵢ}_{,t} or k_{S}_{ⱼ}_{,t} is 0, then there is no interference between the cells k_{S}_{ᵢ}_{,t} and k_{S}_{ⱼ}_{,t}, and the entire subitem is 0, therefore, it is necessary to make the number of k=0 as large as possible. By solving the above equation (1), the adjustment of each group of resource allocation pattern segment may be finally implemented.

A corresponding second resource allocation pattern is obtained by splicing the adjusted at least one group of resource allocation pattern segment, that is, second resource allocation patterns of the cells in the one cell cluster is obtained. Since this has been described in detail above with reference to FIG. 10, the description may not be repeated here.

Returning to the reference to FIG. 1, by the above operations S110 and S120, the second resource allocation pattern of the at least one cell may be obtained, thereby improving the transmission efficiency of the cell, so that cells may shorten the traffic transmission time with the same traffic and provide more idle time for switching off the RU to achieve energy-saving. The method may further include: transmitting the second resource allocation pattern corresponding to the at least one cell to a second network node, wherein the second network node may be a Distribution Unit (DU).

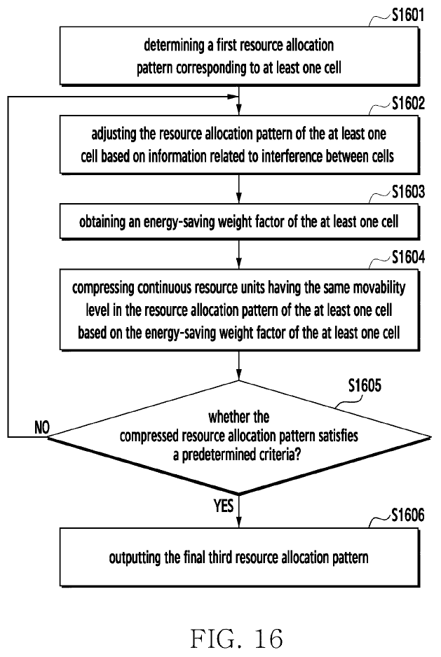

In order to further save energy, the embodiments may also compress the transmission time using a SINR gain of each cell. A method performed by a first network node according to an example embodiment will be described in greater detail below with reference to FIG. 16, which may further compress the transmission time on the basis of the method illustrated in FIG. 1.

FIG. 16 is a flowchart illustrating an example method performed by a first network node according to various embodiments.

Operations S1601 to S1602 in FIG. 16 are the same as or similar to operations S110 to S120 in FIG. 1, and are therefore a description thereof may not be repeated here.

At operation 1603, an energy-saving weight factor of the at least one cell is obtained, wherein the energy-saving weight factor may be selected by the corresponding cell from among a plurality of preset energy-saving weight factors, based on a cell deployment scenario and/or traffic load-related information (which may also be referred to as, a busy or idle status of the cell period. The energy-saving weight factor may be pre-obtained by the first network node, and when the deployment scenario of the cell changes or the traffic load related information (e.g., the busy or idle status of the cell period) changes, the energy-saving weight factor may be received from the base station in real time.

For example, according to Shannon equation, an average data rate C_{S}_{ᵢ} of users within a cell Sᵢ is:

$${C}_{{S}_{i}} = W log ( 1 + S / N ) \qquad ( 4 )$$

Wherein S/N is signal to noise power ratio, which is a dimensionless unit. In a practical engineering application, the S/N may be replaced by SINR. Since a unit of SINR is dB, a conversion relationship between the SINR and the S/N is:

$$S I N R = 10 lg ( S / N ) , S / N = {10}^{SINR / 10} \qquad ( 5 )$$

Therefore, the average data rate C_{S}_{ᵢ} of UEs within the cell Sᵢ may become:

$${C}_{{S}_{i}} = W lg ( 1 + {10}^{SINR / 10} ) \qquad ( 6 )$$

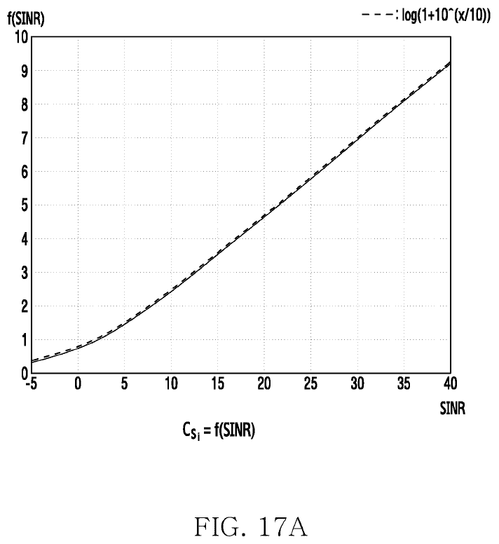

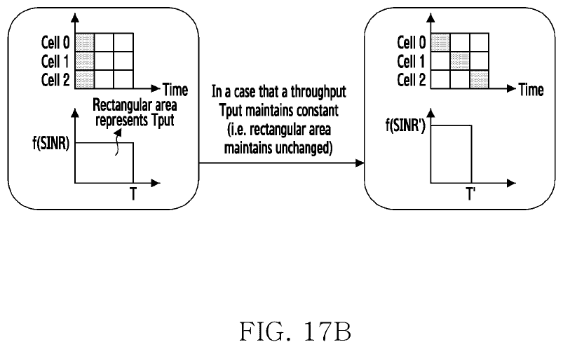

As shown in FIG. 17A, C_{S}_{ᵢ} may be written as a monotonically increasing function of the SNIR:

$${C}_{{S}_{i}} = f ( S I N R ) S I N R ∈ [ - 5 , 40 ] \qquad ( 7 )$$

Assuming that a traffic throughput of one time period T is Tput, then the relationship between Tput and C_{S}_{ᵢ} may be represented as:

$$Tput ∝ f ( S I N R ) \qquad ( 8 )$$

Assuming that there are three cells Cell 0, Cell 1, and Cell 2, interferences between them and a relationship between a traffic transmission duration T and a transmission rate f(SINR) may be represented as shown in FIG. 17B. In order to reduce the interference between cells, the resources of different resource units may be staggered in the time domain, e.g., as shown in the right side accompanying figure in FIG. 17B. After the interference is reduced, f(SINR) increases to f(SINR′), and accordingly, the time T may be reduced to T′, wherein T′ is the minimum transmission duration after transmission rate optimization, and thus, T-T′ represents the additional maximum energy-saving duration caused by a gain of f(SINR). Thus, the cell may determine how much of this additional maximum energy-saving duration T-T′ is available for energy-saving by setting the energy-saving weight factor β, wherein this energy-saving weight factor β may represent an optimization capacity of the cell for energy-saving.

In an embodiment, this energy-saving weight factor may be selected by the cell from among a plurality of preset energy-saving weight factors based on a cell deployment scenario and/or traffic load-related information, wherein the traffic load-related information may be determined using whether the cell is in a busy period or in an idle period, and for example, the busy period and the idle period may be represented by different levels, e.g., the busy period may be divided into a busy period level 1 and a time period level 2, and the idle time period may be divided into an idle period level 1 and an idle period level 2. However, the disclosure is not limited thereto, and the busy period and idle period may be divided into more or less levels. Table 1 below illustrates an example of energy-saving weight factors β set according to cell deployment scenarios and/or traffic load related information:

TABLE 1

| | High-speed | Urban | Rural | | | Large |
|---|---|---|---|---|---|---|
| | rail | area | area | Subway | . . . | venue |
| Busy | β₁ | β₅ | β₉ | β₁₃ | . . . | βₓ₋₃ |
| period | | | | | | |
| level 1 | | | | | | |
| Busy | β₂ | β₆ | β₁₀ | β₁₄ | . . . | βₓ₋₂ |
| period | | | | | | |
| level 2 | | | | | | |
| Idle | β₃ | β₇ | β₁₁ | β₁₅ | . . . | βₓ₋₁ |
| period | | | | | | |
| level 1 | | | | | | |
| Idle | β₄ | β₈ | β₁₂ | β₁₆ | . . . | βₓ |
| period | | | | | | |
| level 2 | | | | | | |

In other words, the cell may select the energy-saving weight factor β based on the following criteria:
(1) According to the traffic load related information (e.g., busy or idle status of the cell period): the setting of β is partial to boosting capacity when the cell is in the busy period, and the setting of β is partial to boosting energy-saving when the cell is in the idle period;
(2) Deployment scenarios of the cell: when there are many UEs in the cell, the setting of β is partial to boosting capacity, and when there are fewer UEs in the cell, the setting of β is partial to boosting energy-saving.

Thus, the cell may select the energy-saving weight factor β from among the plurality of preset energy-saving weight factors based on its deployment scenario and/or traffic load related information, and then transmit this selected energy-saving weight factor β to the first network node, and then the first network node further compresses the transmission time based on this energy-saving weight factor β.

For example, at operation S1604, continuous resource units having the same movability level in the second resource allocation pattern of the at least one cell are compressed based on the energy-saving weight factor of the at least one cell, thereby obtaining a third resource allocation pattern of the at least one cell.

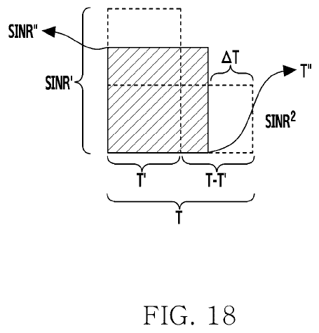

In an embodiment, as described above, the energy-saving weight factor β is used to determine how much of the additional maximum energy-saving duration T-T′ is available for energy-saving, as shown in FIG. 18, since Tput is constant, the adjusted energy-saving duration may be calculated as:

$$Δ T = ( T - {T}^{′} ) β \qquad ( 9 )$$

Wherein, when β tends to 0, the energy-saving duration tends to 0 and therefore is not used for energy-saving, and when β tends to 1, the energy-saving duration tends to the additional maximum energy-saving duration and therefore maximizes and/or improve energy-saving.

Accordingly, the compressed transmission duration T″ is:

$${T}^{″} = T - Δ T = T - ( T - {T}^{′} ) β \qquad ( 10 )$$

In this case, the corresponding SINR becomes SINR″, as shown in FIG. 18, which illustrates a schematic diagram of determining the energy-saving duration by the energy-saving weight factor β.

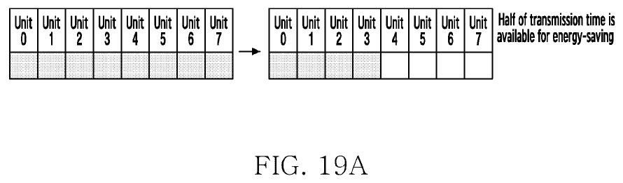

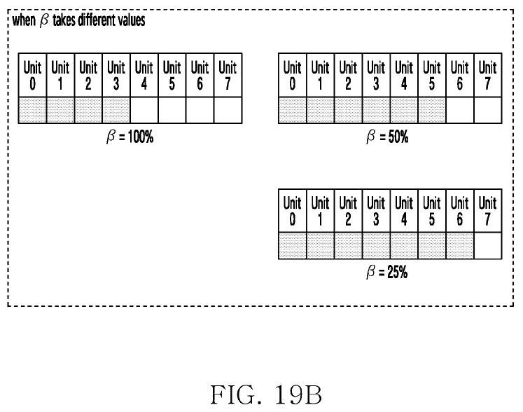

FIGS. 19A and 19B are diagrams illustrating energy-saving effects when energy-saving weight factors take different values according to various embodiments. As shown in FIG. 19A, it is assumed that an increase in SINR results in a doubling of an average data transmission rate during this transmission time, and accordingly, half of the transmission time is available for energy-saving. As shown in FIG. 19B, when β takes 100%, 50%, and 25%, respectively, the energy-saving duration decreases as β decreases, that is, different effects are produced.

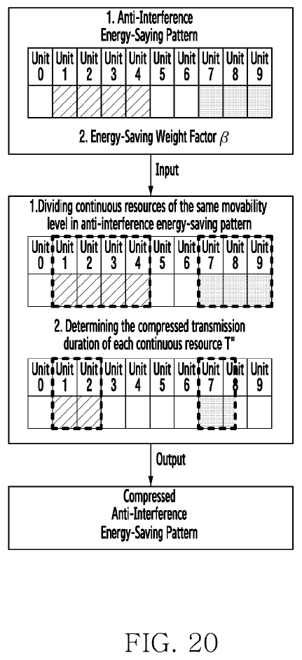

In the adjusted resource allocation pattern of the cell, there may be a plurality of continuous resource units of the same movability level, in other words, resources of the same movability level may occupy a plurality of continuous resource units. Therefore, continuous resource units having the same movability level in the second resource allocation pattern may be compressed according to the energy-saving weight factor β. That is, continuous resource units having the same movability level are compressed in terms of transmission time according to the energy-saving weight factor β, as shown in FIG. 20.

Thus, by the above operation S1604, the third resource allocation pattern of the at least one cell may be obtained.

The method illustrated in FIG. 16 may further include a operation S1605. At the operation S1605, whether the third resource allocation pattern of the at least one cell satisfies the preset criterion is determined.

If it is determined that the third resource allocation pattern of the at least one cell satisfies the preset criterion, then at operation S1606, the third resource allocation pattern of the at least one cell is transmitted to the cell.

If the third resource allocation pattern of the at least one cell does not satisfy the preset criterion, then operations of the operations S1602 to operation S1604 are iteratively performed, that is, it returns to perform the S1602 to operation S1604. For example, at the S1602, the third resource allocation pattern of the at least one cell is adjusted again, and then operation S1603 is optionally performed, that is, the energy-saving weight factor β of the at least one cell is optionally obtained, and then, at operation S1604, the continuous resource units having the same movability level in the adjusted third resource allocation pattern are again compressed. Wherein, operation S1603 is optionally performed, for example, when the deployment scenario of the cell changes or the traffic load related information (e.g., the busy or idle status of the cell period) changes, the cell re-selects the energy-saving weight factor β, and the re-selected energy-saving weight factor β is re-transmitted to the first network node.

Thereafter, the operation proceeds again to the operation S1605, and the determination operation is re-performed until the preset criterion is satisfied.

In the an embodiment, the preset criterion may be one of: a first criterion that the number of iterative operations satisfies a predetermined number of times, for example, the predetermined number of times may be 3, 4, 5 . . . , etc.; a second criterion that a gain of a throughput and a gain of the energy-saving of the at least one cell no longer grows, wherein if the first resource allocation pattern of the at least one cell is adjusted according to the method illustrated in FIG. 12, the second criterion herein represents that the gain of the throughput and the gain of the energy-saving of all cells within one cell cluster no longer grow.

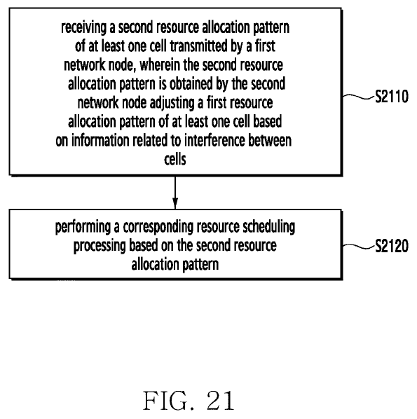

FIG. 21 is a flowchart illustrating an example method performed by a second network node in a communication system according to various embodiments. In an embodiment, the second network node may be, for example, a DU of a base station, but the disclosure is not limited thereto.

As shown in FIG. 21, at operation S2110, a second resource allocation pattern of at least one cell transmitted by a first network node is received, wherein the second resource allocation pattern is obtained by the second network node adjusting a first resource allocation pattern of the at least one cell based on information related to interference between cells, wherein the first network node may be a network node that performs the method as described above with reference to FIG. 1, e.g., a RIC.

In an embodiment, the method may further include: transmitting attribute-related information of the at least one cell to the first network node, for the first network node to determine the first resource allocation pattern corresponding to the at least one cell based on the attribute-related information. The attribute-related information includes historical traffic information and/or energy-saving time granularity information. The method may further include: transmitting the interference-related information of the at least one cell to the first network node. Since the process for receiving information from the second network node by the first network node and determining the first and second resource allocation patterns based on the received information has been described in detail above with reference to FIGS. 1 to 20, it will not be repeated herein.

At operation S2120, a corresponding resource scheduling processing is performed based on the second resource allocation pattern.

Further, the method shown in FIG. 21 may further include: selecting a corresponding energy-saving weight factor from among a plurality of predetermined energy-saving weight factors based on a deployment scenario and/or traffic load-related information of the at least one cell corresponding to the second network node; transmitting the selected energy-saving weight factor to the first network node, wherein the energy-saving weight factor may be used by the first network node for compressing continuous resource units having the same movability level in the second resource allocation pattern of the at least one cell. Since this has been described in detail with reference to FIG. 16, the description may not be repeated here.

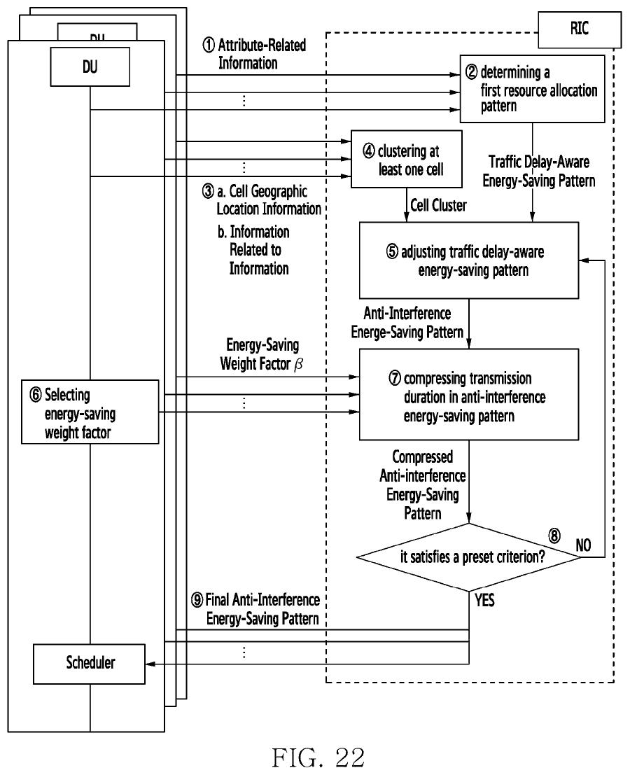

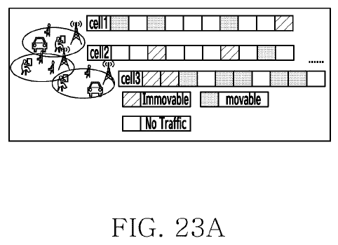

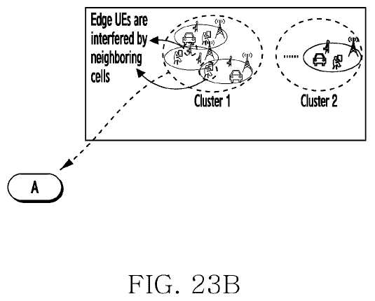

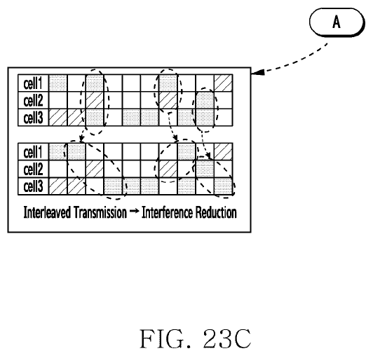

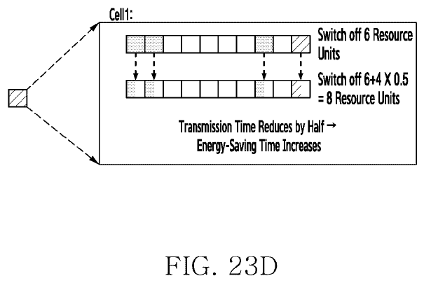

In order to facilitate the understanding of the disclosure, the disclosure herein is described in greater detail below with reference to FIGS. 22 and 23.

FIG. 22 is a flowchart illustrating an example process for determining, by a first network node and a second network node, a final resource allocation pattern according to various embodiments. FIGS. 23A, 23B, 23C and 23D are diagrams illustrating an example process for determining a final resource allocation pattern according to various embodiments.

As shown in FIG. 22, at operation 1, a second network node (e.g., a DU of each base station) periodically transmits attribute-related information to a first network node (e.g., a RIC), wherein the attribute-related information includes historical traffic information and/or energy-saving time granularity information, and in addition, the attribute-related information may further include a public signal and a RS.

At operation 2, the first network node allocates available resources for cells of the second network node based on the public signal and the RS, determines, via the first neural network, a predicted traffic load of the at least one cell and movability levels corresponding to resource units to which resources have been allocated based on the historical traffic information, and then determines a first resource allocation pattern (which may also be referred to as a traffic delay-aware energy-saving pattern) corresponding to the at least one cell based on the energy-saving time granularity information, the allocated available resources, the predicted traffic load, and the movability levels corresponding to the resource units to which the resources have been allocated, as shown in FIG. 23A. This traffic delay-aware energy-saving pattern reflects not only switching-off of resources in the cells, but also reflects an adjustment range of movability of resources in the time domain.

At operation 3, the second network node may transmit information related to interference of the cells to the first network node, e.g., the second network node periodically transmits information related to interference of the cells to the first network node, and in addition, the second network node may transmit geographic location information of the cells to the first network node in an initial deployment of the base station.

At operation 4, the first network node clusters the at least one cell based on the information related to interference of the at least one cell (and/or the geographic location information of the cells), as shown in FIG. 23B, so that the interference of the cells between cell clusters is small and the strong interference is concentrated within a cell cluster, and the subsequent processing of the interference is performed within one cell cluster, so that a complexity of an algorithm is reduced. However, the disclosure may also directly perform the subsequent operations on the at least one cell without clustering the cells, and in the following description, the subsequent description is provided based on clustering the cells.

At operation 5, the first resource allocation pattern of the at least one cell in the cell cluster is adjusted based on the information related to interference between the cells. For example, in order to avoid or reduce the interference between neighboring cells within the cell cluster, the first network node adjusts the first resource allocation pattern (e.g., the traffic delay-aware energy-saving pattern) of the cells in the same cell cluster by, for example, an FFNN, that is, adjusts locations of the resource units for each cell in the time domain, so that the resources that need to be transmitted are staggered in the time domain, thereby generating a second resource allocation pattern (which may also be referred to as an anti-interference energy-saving pattern), and a gain of a SINR of this second resource allocation pattern is calculated. As shown in FIG. 23C, since there is large interference between the cells within each cell cluster, at this operation, the first network node jointly adjusts the first resource allocation pattern (e.g., the traffic delay-aware energy-saving pattern) of the cells based on the movability levels of the resource units, to avoid or minimize and/or reduce the interference between the cells within the cell cluster.

At operation 6, the second network node may select a corresponding energy-saving weight factor β from among a plurality of preset energy-saving weight factors based on a deployment scenario and/or traffic load related information of a cell corresponding to the second network node, and transmit the selected energy-saving weight factor β to the first network node.

At operation 7, the first network node uses the gain of the SINR to compress a transmission duration of the second resource allocation pattern (e.g., the anti-interference energy-saving pattern) of the cells according to the energy-saving weight factor β, to obtain a third resource allocation pattern of the at least one cell to meet an energy-saving target of the cells, as shown in FIG. 23D, so that it can shorten a traffic transmission time under the same traffic, and switches off more time-domain resources for energy-saving, thereby further saving energy.

At operation 8, the first network node determines whether the current obtained third resource allocation pattern (e.g., the compressed anti-interference energy-saving pattern) satisfies a preset criterion for the end of iteration, and if it does not, the operations 5 to 7 are performed repeatedly, wherein the operation 6 may be performed optionally depending on whether the deployment scenario and/or the traffic load-related information of the cell is changed. Through iterative operations of the operations 5 to 7, the compression of the anti-interference energy-saving pattern may be continued to maximize and/or improve the energy-saving. The compression of the transmission duration changes the anti-interference energy-saving pattern in the time domain, and the interference between the cells also changes, and the interference and energy-saving duration may be continuously adjusted based on the new anti-interference energy-saving pattern, until the preset criterion is satisfied.

At operation 9, if the predetermined criterion for the end of the iteration is satisfied, the first network node may output its final anti-interference energy-saving pattern (e.g., the final third resource allocation pattern) to the second network node, and the second network node may utilize a scheduler to perform resource scheduling based on the anti-interference energy-saving pattern.

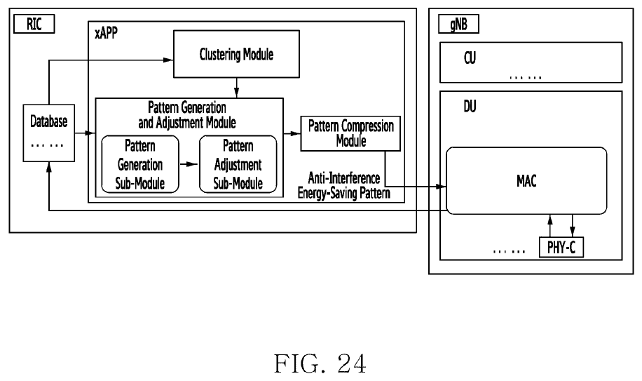

Through the disclosure, less cell power consumption may be achieved without sacrificing a system performance, and interference between the cells may be reduced and transmission efficiency may be improved. In the above descriptions, the first neural network and the second neural network utilized are fully connected networks obtained after training. Wherein, the training manner may be offline-training, however, the disclosure is not limited thereto, and the training method may also be online-training, e.g., online training of the first neural network and the second neural network by a network node utilizing information reported from a base station at a preset period. In addition, the training may be performed by the above-described network node or by another network node, e.g., the first neural network and the second neural network utilized in the method performed by the network node described above may also be a neural network obtained by the network node directly performing the training, or a trained neural network received from outside. The deployment scenario between a network node and a base station is described in greater detail below with reference to FIG. 24.

FIG. 24 is a diagram illustrating an example deployment scenario between a network node and a base station according to various embodiments. In the embodiment described with reference to FIG. 24, the network node is a first network node as described above (e.g., a RIC), but the disclosure is not limited thereto.

Referring to FIG. 24, the method described above with reference to FIG. 1 performed by the first network node is deployed as an xAPP on a RIC, and the method described above with reference to FIG. 21 performed by the second network node is deployed on a DU of a base station (e.g., a gNB).

The pattern generation and adjustment module includes a pattern generation sub-module and a pattern adjustment sub-module. Firstly, the pattern generation and adjustment module acquires attribute-related information of cells reported by the base station from a database of the RIC, for example, which includes but not limited to, historical traffic information and energy-saving time granularity information, and may also include a public signal and a RS.

The pattern generation sub-module allocates available resources for cells based on the public signal and the RS included in the received attribute-related information, determines a predicted traffic load of at least one cell and movability levels corresponding to resource units to which resources have been allocated based on the historical traffic information included in the attribute-related information via the trained first neural network, determines a first resource allocation pattern (hereinafter referred to as a traffic delay-aware energy-saving pattern) corresponding to the at least one cell based on the energy-saving time granularity information included in the attribute-related information, the allocated available resources, the predicted traffic load, and the movability levels corresponding to the resource units to which the resources have been allocated.

Based on cell geographic location information and information related to interference of the cells reported by the base station in the database, a clustering module may cluster the at least one cell and transmit a clustering result to the pattern generation and adjustment module.

The pattern adjustment sub-module in the pattern generation and adjustment module utilizes a trained second neural network to adjust the first resource allocation pattern of the at least one cell (or the at least one cell in the same cell cluster), to obtain a corresponding second resource allocation pattern (e.g., an anti-interference energy-saving pattern).

The pattern generation and adjustment module outputs the generated second resource allocation pattern to a pattern compression module. The pattern compression module may compress the second resource allocation pattern of the at least one cell based on an energy-saving weight factor (also referred to as a weight factor) of the cell reported by the base station to obtain a final third resource allocation pattern (e.g., a final anti-interference energy-saving pattern). Thereafter, the pattern compression module transmits the obtained final third resource allocation pattern to the corresponding DU.

A MAC layer in the DU executes a resource scheduler to control a physical layer PHY-C to transmit data to a UE in the cell based on the received third resource allocation pattern, and the PHY-C periodically transmits measurement data to the MAC layer, wherein the measurement data may be used for calculating a SINR and for being reported to the first network node by the base station for subsequent generation of the resource allocation pattern.

The MAC layer collects the measurement data reported by the PHY-C layer and may selectively report the collected measurement data (e.g., historical traffic information, a public signal, a RS, energy-saving time granularity information, information related to interference) to the first network node, and may report the cell geographic location information to the first network node in an initial deployment of the base station. In addition, the MAC layer transmits the selected energy-saving weight factor to the first network node. These reported information may be stored in a database and may be used by the first network node for inferring operations of the traffic delay-aware energy-saving pattern and the anti-interference energy-saving pattern, and may be utilized by the first network node to train the first neural network and the second neural network, however, the disclosure is not limited thereto, and the first network node may also transmit these reported information to other network nodes, for the other network nodes training the first neural network and the second neural network.

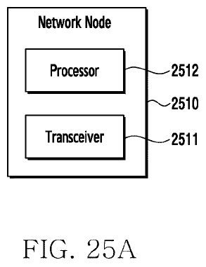

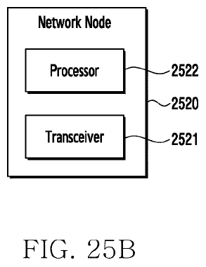

FIG. 25A is a block diagram illustrating an example configuration of a first network node according to various embodiments.

As shown in FIG. 25A, the first network node 2510 includes a transceiver 2511 and a processor (e.g., including processing circuitry) 2512, wherein the processor 2512 is coupled to the transceiver 2511 and configured to perform the method performed by the first network node described for example with reference to FIGS. 1 to 20. The details of operations of the method performed by the first network node mentioned above may be referred to the descriptions in FIGS. 1 to 20, and may not be repeated here.

FIG. 25B is a block diagram illustrating an example configuration of a second network node according to various embodiments.

As shown in FIG. 25B, the second network node 2520 includes a transceiver 2521 and a processor (e.g., including processing circuitry) 2522, wherein the processor 2522 is coupled to the transceiver 2521 and configured to perform the method performed by the second network node described above with reference to FIG. 21. The details of operations of the method performed by the second network node mentioned above may be referred to the descriptions in FIG. 21, and may not be repeated here.

An embodiment of the present disclosure also provides an electronic apparatus, the electronic apparatus includes a processor, and alternatively, further includes at least one transceiver and/or at least one memory coupled to the at least one processor, the at least one processor is configured to perform the steps of the method provided in any optional embodiment of the present disclosure. The processor(s) of FIGS. 25A and 25B may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions.

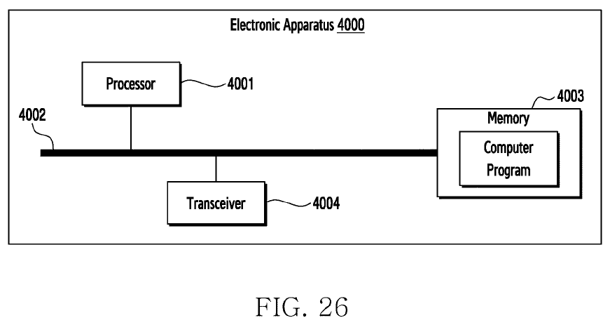

FIG. 26 is a diagram illustrating an example configuration of an electronic apparatus according to various embodiments. As shown in FIG. 26, the electronic apparatus 4000 shown in FIG. 26 includes: a processor (e.g., including processing circuitry) 4001 and a memory 4003. Wherein the processor 4001 and the memory 4003 are coupled, e.g., through a bus 4002. The electronic apparatus 4000 may further include a transceiver 4004 which may be used for data interaction between the electronic apparatus and other electronic apparatuses, such as transmitting of data and/or receiving of data. It should be noted that, each of the processor 4001, the memory 4003, and the transceiver 4004 is not limited to one in a practice application, and the structure of the electronic apparatus 4000 is not a limitation on the various embodiments of the present disclosure. The electronic apparatus may be the first network node, the second network node, or the third network node.

The processor 4001 may be a Central Processing Unit (CPU), general purpose processor, Digital Signal Processor (DSP), Application Specific Integrated Circuit (ASIC), Field Programmable Gate Array (FPGA) or other programmable logic device, transistor logic device, hardware part, or any combination thereof. It may implement or perform various example logic boxes, modules, and circuits described in conjunction with the disclosed contents of the present disclosure. The processor 4001 may also be a combination that implements computing functions, such as a combination containing one or more microprocessors, a combination of a DSP and a microprocessor, and the like. The processor 4001 may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions.

The bus 4002 may include a pathway to transfer information between the above components. The bus 4002 may be a Peripheral Component Interconnect (PCI) bus or an Extended Industry Standard Architecture (EISA) bus, and the like. The bus 4002 may be classed as an address bus, a data bus, a control bus, and the like. For ease of representation, only one bold line is shown in FIG. 26, but it does not refer to there being only one bus or one type of bus.

The memory 4003 may be a Read Only Memory (ROM) or other types of static storage apparatuses that can store static information and instructions, a Random Access Memory (RAM) or other types of dynamic storage apparatuses that can store information and instructions, may be an Electrically Erasable Programmable Read Only Memory (EEPROM), Compact Disc Read Only Memory (CD-ROM) or other optical disc storages, an optical disc storage (including a compressed disc, laser disc, optical disc, digital universal disc, Blu-ray disc, etc.), a disk storage medium, other magnetic storage apparatuses, or any other medium that can be used to carry or store computer programs and can be read by a computer, it is not limited herein.

The memory 4003 may be used to store computer programs or executable instructions for performing the embodiments of the present disclosure, and is controlled for execution by the processor 4001. The processor 4001 is used to execute the computer programs or executable instructions stored in the memory 4003 to implement the operations shown in the preceding method of the embodiments.

An embodiment of the present disclosure provides a computer-readable storage medium storing computer programs or instructions, the computer programs or instructions, when being executed by at least one processor may perform or implement the operations in the preceding method of the embodiments and corresponding contents.

An embodiment of the present disclosure provides a computer program product including computer programs, the computer programs, when being executed by a processor, may implement the operations and corresponding contents shown in the preceding method of the embodiments.

The above describes an example method performed by a network node and the corresponding network node according to various embodiments, and the following is a comparison with the prior art in terms of the effects in applying the method.

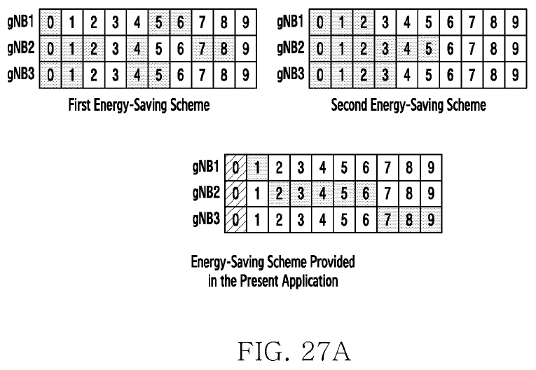

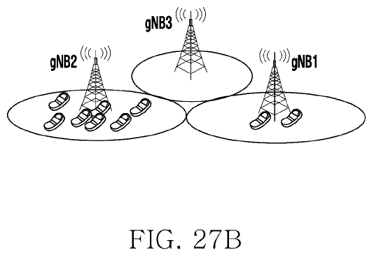

FIG. 27A is a diagram illustrating a comparison result of applying a scheme of the disclosure and the prior art under a first assessment condition.

First assessment condition:
(1) A contrast group: three neighboring cells, a plurality of user equipment (UEs), and a user traffic type of a Constant Bit Rate (CBR) traffic (1300 bytes per 10 ms), wherein a distribution of the three neighboring cells is shown in FIG. 27B. A network node in this cell performs a downlink communication with the plurality of UEs. Using the scheme of the disclosure (which may be referred to as an energy-saving scheme based on a coordination of interference between cells), a load of each cell is set to be independently different with each other, and time-domain resources used by cells, an Internet Protocol (IP) throughput (Tput) of the UEs, and an energy consumption of the network node are recorded. A distribution of time domain resource usage, the IP Tput of the UEs and the energy consumption of the network node of each cell under the scheme of the disclosure are used as contrast values. These contrast values are used as references for an experimental group (e.g., used as references for the distribution of the time domain resource usage, the IP Tput of the UEs, and the energy consumption of the network node of the experimental group under the same load condition as under the conventional energy-saving scheme).
(2) An experimental Group 1: Cells, UE distribution, UE number and UE traffic configuration are the same as those of the contrast group, and the difference is that the experimental group 1 adopts a traditional first energy-saving scheme in which a symbol/timeslot is switched on/switched off. Under the same traffic scenario (e.g., the number of the UEs and the traffic type are the same), the first energy-saving scheme will switch off a RF transmission (e.g., switch off an RU) when there is no traffic transmission.
(3) An experimental Group 2: Cells, UE distribution, UE number and UE traffic configuration are the same as those of the contrast group, and the difference is that the experimental group 2 adopts an existing second energy-saving scheme which is different from the first energy-saving scheme. Under the same traffic scenario (e.g., the number of the UEs and the traffic type are the same), this second energy-saving scheme concentrates a cell transmission time through traffic prediction, while saving more power when the cell energy-saving time is concentrated.

It can be seen from FIG. 27A that the first energy-saving scheme of the experimental group 1 has a more random distribution of the time-domain resources and an energy-saving effect is limited. The second energy-saving scheme of the experimental group 2 achieves the centralized time domain resource distribution after considering the traffic prediction, but due to an independent implementation of the energy-saving schemes by each cell, there is more overlap of time-domain resources transmitted by each cell, which affects the IP Tput of the UE. However, the scheme of the disclosure allows coordination between the cells, so as to avoid interference between cells, and be able to further save energy while improving transmission efficiency.

In addition, the scheme of the disclosure has a higher IP Tput and a lower energy consumption.

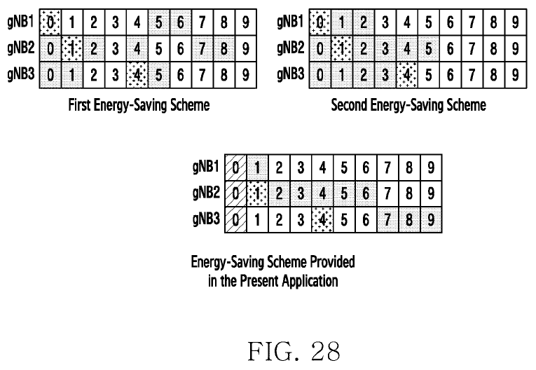

FIG. 28 is a diagram illustrating a comparison result of applying a scheme of the disclosure and the prior art under a second assessment condition.

### Second Assessment Condition:

(1) A contrast group: three neighboring cells, a plurality of UEs, and user traffic types of a Voice Over Internet Protocol (VOIP) traffic and a CBR traffic (1300 bytes per 10 ms), wherein a distribution of the three neighboring cells is shown in FIG. 27B. A network node of cells performs a downlink communication with the plurality of UEs. Using the scheme of the disclosure (which can be referred to as an energy-saving scheme based on coordination of interference between cells), a load of each cell is set to be independently different with each other, and time-domain resources used by the network node, an IP Tput of the UEs, and an energy consumption of the network node are recorded.
(2) An experimental group 1 and an experimental group 2: Cells, UE distribution, UE number and UE traffic configuration are the same as those of the contrast group. The differences are that the experimental group 1 adopts a traditional first energy-saving scheme in which a symbol/timeslot is switched on/switched off, and the experimental group 2 adopts an existing second energy-saving scheme which is different from the first energy-saving scheme.

Compared with the first assessment condition, the second assessment condition adds the VOIP traffic, and yellow marked in FIG. 28 gives time-domain locations where delay-sensitive VOIP traffics are located. As shown in FIG. 28, even if there are time-domain sensitive traffics, the distribution of time-domain resources of the scheme of the disclosure may achieve an effect of further saving time-domain resources.

Relative to the second energy-saving scheme, the scheme of the disclosure further reduces energy consumption while a UE average IP Tput performance is optimal among the compared energy-saving schemes.

The terms “first”, “second”, “third”, “fourth”, “1”, “2” and the like (if exists) in the disclosure and the above drawings are used to distinguish similar objects, and need not be used to describe a specific order or sequence. It should be understood that, data used as such may be interchanged in appropriate situations, so that various embodiments of the present disclosure described here may be implemented in an order other than the illustration or text description.

It should be understood that, although each operation is indicated by an arrow in the flowcharts of various embodiments of the present disclosure, an implementation order of these operations is not limited to an order indicated by the arrows. Unless explicitly stated herein, in some implementation scenarios of various embodiments of the present disclosure, the implementation operations in the flowcharts may be executed in other orders according to requirements. In addition, some or all of the operations in each flowchart may include a plurality of sub operations or stages, based on an actual implementation scenario. Some or all of these sub operations or stages may be executed at the same time, and each sub operation or stage in these sub operations or stages may also be executed at different times. In scenarios with different execution times, an execution order of these sub operations or stages may be flexibly configured according to a requirement, which is not limited by various embodiments of the present disclosure.

The above descriptions and accompanying drawings are provided as examples to assist readers in understanding the present disclosure. They are not intended and should not be interpreted as limiting the scope of the present disclosure in any way. Although certain embodiments and examples have been provided, based on the content disclosed herein, it is apparent to those skilled in the art that, changes can be made to the illustrated embodiments and examples without departing from the scope of the present disclosure, and other similar implementation methods based on the technical concepts of the present disclosure also belongs to a protection scope of the embodiments of the present disclosure. It will also be understood that any of the embodiment(s) described herein may be used in conjunction with any other embodiment(s) described herein.

What is claimed is:

1. A method performed by a network controller in a communication system, comprising:
determining a first resource allocation pattern corresponding to at least one cell, the first resource allocation pattern comprising a movability level corresponding to a resource unit;
obtaining a second resource allocation pattern corresponding to the at least one cell, by adjusting the first resource allocation pattern of the at least one cell based on information related to interference between cells; and
transmitting the second resource allocation pattern to a network node,
wherein the movability level indicates an adjustable range for the resource unit in a time domain.

2. The method according to claim 1,
wherein the network controller comprises a radio access network intelligent controller (RIC) and the network node comprises a distributed unit (DU),
wherein the movability level is related to at least one of a traffic load, a traffic priority, or a delay-related characteristic of a traffic, and
wherein the delay-related characteristic comprises at least one of a resource type, a traffic priority, or a maximum acceptable delay.

3. The method according to claim 1, wherein determining the first resource allocation pattern corresponding to the at least one cell comprises:
acquiring attribute-related information of the at least one cell; and
determining the first resource allocation pattern corresponding to the at least one cell based on the attribute-related information.

4. The method according to claim 3, wherein the attribute-related information comprises historical traffic information and/or energy-saving time granularity information.

5. The method according to claim 4, wherein the determining the first resource allocation pattern corresponding to the at least one cell based on the attribute-related information comprises:
allocating available resources for the at least one cell; and
determining, via a first neural network, a predicted traffic load of the at least one cell and movability levels corresponding to resource units to which resources have been allocated, based on the historical traffic information; and
determining the first resource allocation pattern corresponding to the at least one cell based on the energy-saving time granularity information, the allocated available resources, the predicted traffic load, and the movability levels corresponding to the resource units to which the resources have been allocated.

6. The method according to claim 5,
wherein the first neural network comprises a first sub-neural network, a second sub-neural network and a third sub-neural network,
wherein the determining, via the first neural network, the predicted traffic load of the at least one cell and the movability levels corresponding to the resource units to which the resources have been allocated, based on the historical traffic information comprises:
determining, through the first sub-neural network, the predicted traffic load of the at least one cell based on the historical traffic information;
determining, through the second sub-neural network, delay-related characteristics of the resource units to which the resources have been allocated, based on the predicted traffic load and traffic types corresponding to the resource units to which the resources have been allocated; and
determining, through the third sub-neural network, the movability levels corresponding to the resource units to which the resources have been allocated, based on the delay-related characteristics of the resource units to which the resources have been allocated.

7. The method according to claim 6,
wherein the historical traffic information comprises at least one historical traffic log, and
wherein the determining, through the first sub-neural network, the predicted traffic load of the at least one cell based on the historical traffic information comprises:
determining, through a temporal convolutional network in the first sub-neural network, the predicted traffic load of each historical traffic log corresponding to each resource unit based on the at least one historical traffic log of the at least one cell, and
obtaining the predicted traffic load of the at least one cell, by fusing, through a fusion network in the first sub-neural network, the predicted traffic load of each historical traffic log corresponding to each resource unit, for the at least one cell.

8. The method according to claim 1, wherein the adjusting the first resource allocation pattern of the at least one cell based on the information related to interference between cells comprises:
obtaining at least one cell cluster by clustering the at least one cell; and
obtaining a corresponding second resource allocation pattern by adjusting a first resource allocation pattern of at least one cell within a cell cluster, based on the information related to interference between cells within each cell cluster.

9. The method according to claim 8, wherein the clustering the at least one cell comprises:
clustering the at least one cell based on the information related to interference of the at least one cell,
wherein an interference intensity between cells within one cell cluster is not less than a set threshold, and
wherein an interference intensity between cells in different cell clusters is less than the set threshold.

10. The method according to claim 1, wherein the adjusting the first resource allocation pattern of the at least one cell based on the information related to interference between cells comprises:
adjusting the first resource allocation pattern of the at least one cell based on the movability levels corresponding to the resource units and an interference relationship between cells.

11. The method according to claim 10, wherein the adjusting the first resource allocation pattern of the at least one cell based on the movability levels corresponding to the resource units and the interference relationship between cells comprises:
adjusting, through a second neural network, locations of the resource units in the time domain in the first resource allocation pattern of the at least one cell based on the movability levels corresponding to the resource units and the interference relationship between cells.

12. The method according to claim 11, wherein the adjusting, through the second neural network, the locations of the resource units in the time domain in the first resource allocation pattern of the at least one cell based on the movability levels corresponding to the resource units and the interference relationship between cells comprises:
obtaining at least one group of resource allocation pattern segment, by segmenting the first resource allocation pattern of the at least one cell according to a first length;
adjusting, through the second neural network, the locations of the resource units in the time domain in the at least one group of resource allocation pattern segment based on the movability levels corresponding to the resource units and the interference relationship between cells;
obtaining a corresponding second resource allocation pattern by splicing the adjusted at least one group of resource allocation pattern segment.

13. The method according to claim 1, further comprising:
obtaining a third resource allocation pattern of the at least one cell, by compressing continuous resource units having the same movability level in the second resource allocation pattern of the at least one cell.

14. A network controller, comprising:
a transceiver configured to transmit and/or receive signals;
at least on processor, comprising processing circuitry, coupled to the transceiver; and
memory storing instructions that, when executed by the at least one processor individually and/or collectively, cause the network node to:
determine a first resource allocation pattern corresponding to at least one cell, the first resource allocation pattern comprising a movability level corresponding to a resource unit; and
obtain a second resource allocation pattern corresponding to the at least one cell, by adjusting the first resource allocation pattern of the at least one cell based on information related to interference between cells;
transmit the second resource allocation pattern to a network node
wherein the movability level indicates an adjustable range for the resource unit in a time domain.

15. The network controller according to claim 14,
wherein the movability level is related to at least one of a traffic load, a traffic priority, or a delay-related characteristic of a traffic, and
wherein the delay-related characteristic comprises at least one of a resource type, a traffic priority, or a maximum acceptable delay.

16. The network controller according to claim 14, wherein, to determine the first resource allocation pattern corresponding to the at least one cell, the instructions, when executed by the at least one processor individually and/or collectively, cause the network controller to:
acquire attribute-related information of the at least one cell; and
determine the first resource allocation pattern corresponding to the at least one cell based on the attribute-related information.

17. The network controller according to claim 16, wherein the attribute-related information comprises historical traffic information and/or energy-saving time granularity information.

18. The network controller according to claim 17, wherein, to determine the first resource allocation pattern corresponding to the at least one cell, the instructions, when executed by the at least one processor individually and/or collectively, cause the network controller to:
allocate available resources for the at least one cell; and
determine, via a first neural network, a predicted traffic load of the at least one cell and movability levels corresponding to resource units to which resources have been allocated, based on the historical traffic information; and
determine the first resource allocation pattern corresponding to the at least one cell based on the energy-saving time granularity information, the allocated available resources, the predicted traffic load, and the movability levels corresponding to the resource units to which the resources have been allocated.

19. The network controller according to claim 18,
wherein the first neural network comprises a first sub-neural network, a second sub-neural network and a third sub-neural network,
wherein, to determine, via the first neural network, the predicted traffic load of the at least one cell and the movability levels corresponding to the resource units to which the resources have been allocated, based on the historical traffic information, when executed by the at least one processor, cause the network controller to:
determine, through the first sub-neural network, the predicted traffic load of the at least one cell based on the historical traffic information;
determine, through the second sub-neural network, delay-related characteristics of the resource units to which the resources have been allocated, based on the predicted traffic load and traffic types corresponding to the resource units to which the resources have been allocated; and
determine, through the third sub-neural network, the movability levels corresponding to the resource units to which the resources have been allocated, based on the delay-related characteristics of the resource units to which the resources have been allocated.

20. A non-transitory computer-readable storage medium storing instructions, wherein the instructions, when executed by at least one processor, individually and/or collectively, cause an electronic device to perform the operations comprising:
determining a first resource allocation pattern corresponding to at least one cell, the first resource allocation pattern comprising a movability level corresponding to a resource unit;
obtaining a second resource allocation pattern corresponding to the at least one cell, by adjusting the first resource allocation pattern of the at least one cell based on information related to interference between cells; and
transmitting the second resource allocation pattern to a network node,
wherein the movability level indicates an adjustable range for the resource unit in a time domain.
